(19) United States
(12) Patent Application Publication
(10) Pub. No.: US 2016/0173838 A1
(43) Pub. Date: Jun. 16, 2016

(54) IMAGE PROCESSING APPARATUS, AND IMAGE PROJECTION SYSTEM

(71) Applicant: Mitomo MAEDA, Kanagawa (JP)

(72) Inventor: Mitomo MAEDA, Kanagawa (JP)

(21) Appl. No.: 14/955,540

(22) Filed: Dec. 1, 2015

(30) Foreign Application Priority Data
Dec. 12, 2014 (JP) 2014-252140

(51) Int. Cl. H04N 9/31; G02B 26/08

(52) U.S. Cl. CPC H04N 9/3147; H04N 9/3185; H04N 9/3194; G02B 26/085

(57) ABSTRACT

An image processing apparatus employable for an image projection system configurable with a plurality of image projection apparatuses includes a shift amount calculator to calculate a pixel shift amount for projection images projected by a first image projection apparatus and a second projection image projected by a second image projection apparatus on a projection face when a shift control of a light modulation device is performed for the first and second image projection apparatuses with a given cycle, a shift amount adjuster to calculate a deviation amount of the pixel shift amount of the first and second image projection apparatuses, and calculate a corrected shift amount to set the same pixel shift amount or to reduce the deviation amount of the pixel shift amount, and a shift amount output unit to transmit the corrected shift amount to at least one of first and second image projection apparatus.

### CROSS-REFERENCE TO RELATED APPLICATION

This application claims priority pursuant to 35 U.S.C. §119(a) to Japanese Patent Application No. 2014-252140, filed on Dec. 12, 2014 in the Japan Patent Office, the disclosure of which is incorporated by reference herein in its entirety.

### BACKGROUND

1. Technical Field

The present invention relates to an image processing apparatus and an image projection system.

2. Background Art

Image projection apparatuses such as projectors include a light modulation device and an optical unit having a plurality of lenses to project images onto a projection face such as a screen, in which the light modulation device generates an image based on image data transmitted from a personal computer (PC) or a digital camera by using light emitted from a light source, and the optical unit projects the generated image on the projection face. The light modulation device employs, for example, a liquid crystal panel, a digital micro mirror device (DMD) or the like.

The resolution of the projection image projected by the image projection apparatus can be enhanced by increasing the pixel density of the light modulation device, but the manufacturing cost of the light modulation device increases.

Further, a multi-projection system can be configured with two or more image projection apparatuses, in which each one of the image projection apparatuses projects an image on different projection areas, and the images projected by the two or more image projection apparatuses are combined to project one target image. For example, image data corresponding to the one target image is divided into a plurality of sub-image data and supplied to each of the image projection apparatuses, and then the plurality of image projection apparatuses project a plurality of sub-images to display the one target image. The multi-projection system can display the image on a large screen with higher resolution.

As to the multi-projection system, the adjacent sub-images are overlapped at edge areas of the adjacent sub-images, which is referred to an overlapping area or an image stitching area. Since a user may recognize or perceive some discrepancy of pixels of the same data at the overlapping area of adjacent sub-images, the positions and light intensity of the adjacent sub-images are required to be controlled so that pixels of the same data do not deviate at the overlapping area of the adjacent sub-images. For example, the pixel shifting control can be performed.

However, when the pixel shifting control is performed for each of the image projection apparatuses in the multi-projection system by shifting the light modulation device, the shift amount of the light modulation device of each one of the image projection apparatuses becomes different due to the difference of the projection distance and the projection size, with which images at the overlapping area or image stitching area may become unclear images, and thereby visual perception of images may degrade.

### SUMMARY

In one aspect of the present invention, an image processing apparatus employable for an image projection system is devised. The image processing apparatus is employable for an image projection system configurable with a plurality of image projection apparatuses including at least first and second image projection apparatuses for projecting first and second projection images on a projection face by overlapping a part of the first projection image and a part of the second projection image at an overlapping area, The image processing apparatus includes a shift amount calculator to calculate a pixel shift amount for the first projection image projected by the first image projection apparatus on the projection face, and a pixel shift amount for the second projection image projected by the second image projection apparatus on the projection face when each of the first and second image projection apparatuses performs a shift control of a light modulation device disposed in each of the first and second image projection apparatuses with a given cycle, a shift amount adjuster to calculate a deviation amount of the pixel shift amount of the first image projection apparatuses and the pixel shift amount of the second image projection apparatus, and calculate a corrected shift amount to set the same pixel shift amount to the first and second image projection apparatuses or to reduce the deviation amount of the pixel shift amount of the first image projection apparatus and the pixel shift amount of the second image projection apparatus, and a shift amount output unit to transmit the corrected shift amount to at least one of first and second image projection apparatus that requires a correction of the pixel shift amount.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein

FIG. 1 is a schematic view of an image projection apparatus 1 of one or more example embodiments of the present invention;

FIG. 2A is a functional block diagram of the image projection apparatus;

FIG. 2B is a hardware configuration of a system controller of the image projection apparatus;

FIG. 3 is a schematic perspective view of an optical engine of the image projection apparatus;

FIG. 4 is a schematic internal perspective view of a light guiding unit of the image projection apparatus;

FIG. 5 is a schematic internal perspective view of an image projection unit of the image projection apparatus;

FIG. 6 is a schematic perspective view of an image generation unit of the image projection apparatus;

FIG. 7 is a schematic side view of the image generation unit;

FIG. 8 is a schematic perspective view of a fixed unit of the image projection apparatus;

FIG. 9 is a schematic perspective view of the disassembled fixed unit;

FIG. 10 is a side view of a support structure for a moveable plate supported by the fixed unit;

FIG. 11 is a partial expanded view of the support structure indicated by “A” in FIG. 10;

FIG. 12 is a bottom view of a top plate of a moveable unit:

FIG. 13 is a schematic perspective view of a moveable unit;

FIG. 14 is a schematic perspective view of the disassembled moveable unit;

FIG. 15 is a schematic perspective view of a moveable plate of a moveable unit;

FIG. 16 is a schematic perspective view of the moveable unit removing the moveable plate;

FIG. 17 is a side view of a DMD holding configuration set for the moveable unit;

FIG. 18A is an example system configuration of a multi-projection system, and a functional block diagram of the image processing apparatus of the multi-projection system;

FIG. 18B is a hardware configuration of a control unit of the image processing apparatus;

FIGS. 19A and 19B are examples of test pattern images projected from the image projection apparatus indicating difference of shift amount of light modulation devices;

FIGS. 20A and 20B illustrate a scheme of adjustment of the shift amount of the light modulation devices;

FIG. 21 is one example of a sequence chart of operations of the multi-projection system;

FIG. 22 is another example of a sequence chart of operations of the multi-projection system; and

FIG. 23 is another example of a sequence chart of operations of the multi-projection system.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views illustrated in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more example embodiments are described hereinafter.

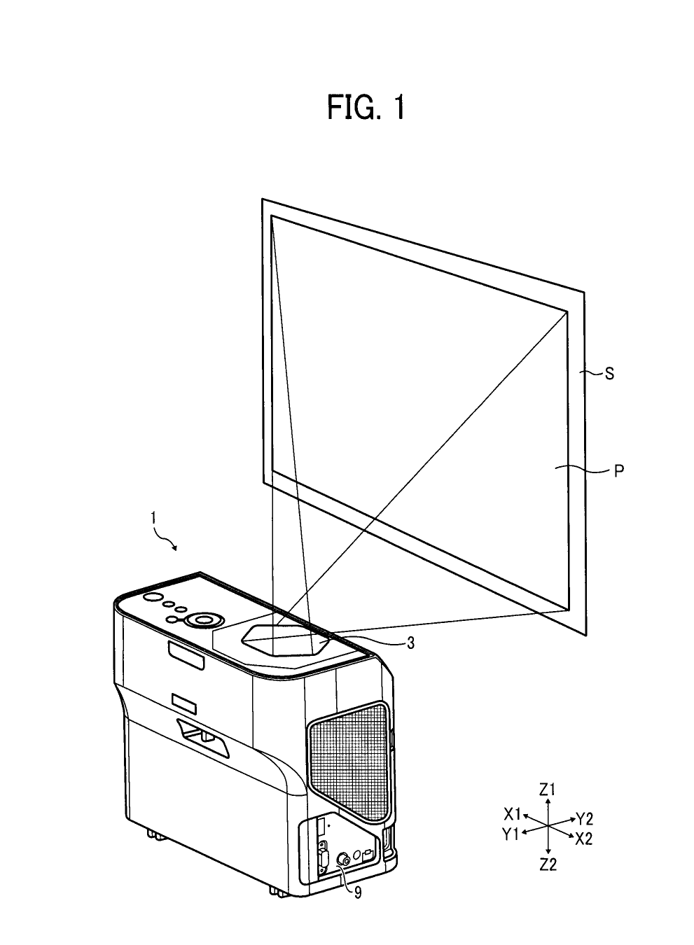

A description is given of one or more example embodiments of the present invention with reference to FIGS. 1 to 23.

### First Example Embodiment

### Image Projection Apparatus and Pixel Shift Mechanism

A description is given of an image projection apparatus 1 configuring an image projection system, and a pixel shift mechanism of the image projection apparatus 1 with reference to FIGS. 1 to 17.

### (Configuration of Image Projection Apparatus)

The image projection apparatus (image projection apparatus 1) of one or more example embodiments of the present invention includes, for example, a light source (light source 30) to emit light, an image generation unit (image generation unit 50) including a light modulation device (DMD 551) to generate an image by using the light emitted from the light source, a light guide unit (light guiding unit 40) to guide the light emitted from the light source to the image generation unit, a projection unit (image projection unit 60) to project the image generated by the image generation unit, a shift-movement controller (movement controller 12) to move the light modulation device between a first position (reference or original position) and a second position shift-able from the first position with a given cycle.

FIG. 1 is a schematic view of an image projection apparatus 1 of one or more example embodiments of the present invention. The image projection apparatus 1 includes, for example, a light exit window 3, an external interface (I/F) 9, and an optical engine to generate a projection image inside the image projection apparatus 1. For example, when image data is transmitted from a personal computer (PC) and/or a digital camera connected or coupled to the external I/F 9, the optical engine of the image projection apparatus 1 generates a projection image based on the transmitted image data, and projects an image P onto a screen S through the light exit window 3 as illustrated in FIG. 1.

In this description, X1-X2 direction corresponds to the width direction of the image projection apparatus 1, Y1-Y2 direction corresponds to the depth direction of the image projection apparatus 1, and Z1-Z2 direction corresponds to the height direction of the image projection apparatus 1. As to the image projection apparatus 1, the light exit window 3 is set as the upper side of the image projection apparatus 1, and the opposite side of the light exit window 3 is set as the lower side of the image projection apparatus 1.

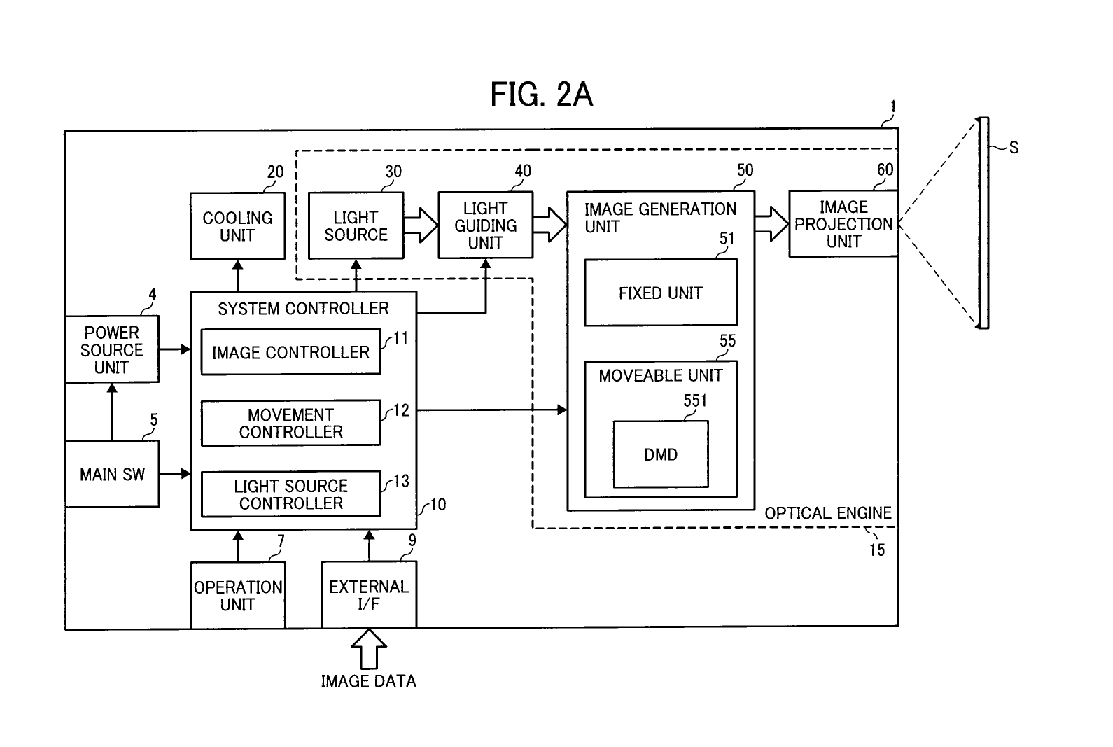

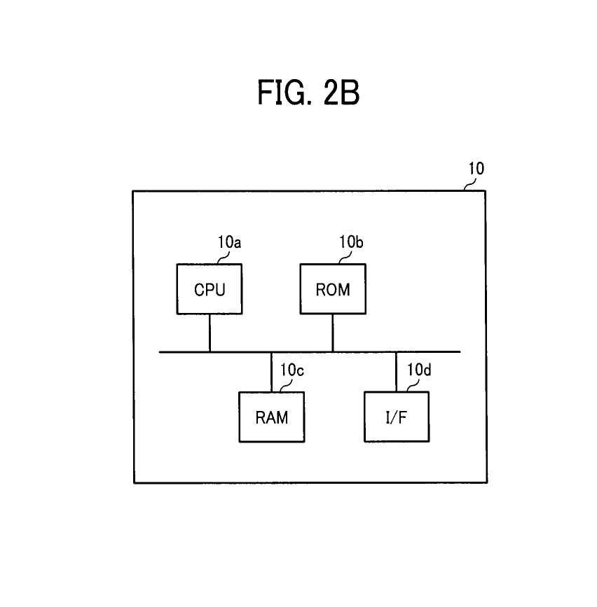

FIG. 2A is a functional block diagram of the image projection apparatus 1. As illustrated in FIG. 2A, the image projection apparatus 1 includes, for example, a power source unit 4, a main switch (SW) 5, an operation unit 7, an external interface (I/F) 9, a system controller 10, a cooling unit 20, and an optical engine 15.

The power source unit 4 is connected or coupled to a commercial power source. The power source unit 4 converts voltage and frequency of the commercial power source to voltage and frequency matched to internal circuits of the image projection apparatus 1, and supplies power to the system controller 10, the cooling unit 20, and the optical engine 15 or the like.

The main SW 5 is used to switch ON-OFF operations of the image projection apparatus 1 by a user. When the power source unit 4 is connected to the commercial power source via a power cable, and the main SW 5 is turned ON, the power source unit 4 starts to supply power to each unit in the image projection apparatus 1. By contrast, when the main SW 5 is turned OFF, the power source unit 4 stops power supply to each unit in the image projection apparatus 1.

The operation unit 7 includes buttons used for receiving various operations by a user. For example, the operation unit 7 can be disposed on a top face of the image projection apparatus 1. The operation unit 7 receives operations by the user such as size setting, color tone setting, and focus adjustment of a projection image. The user's operations received by the operation unit 7 are transmitted to the system controller 10.

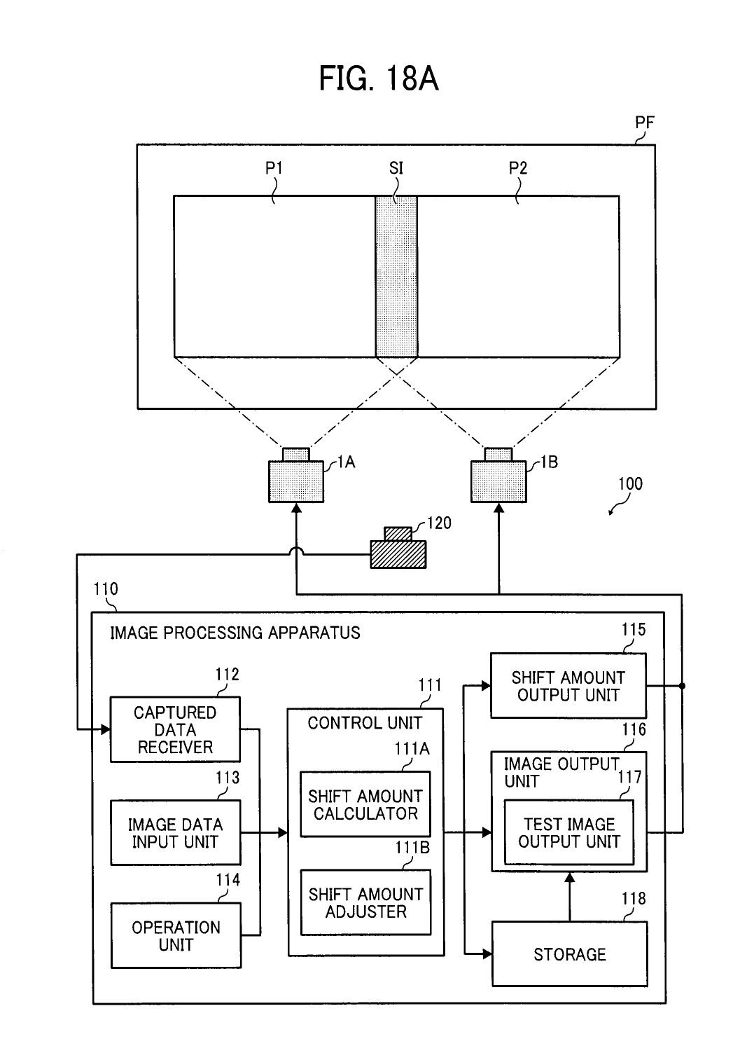

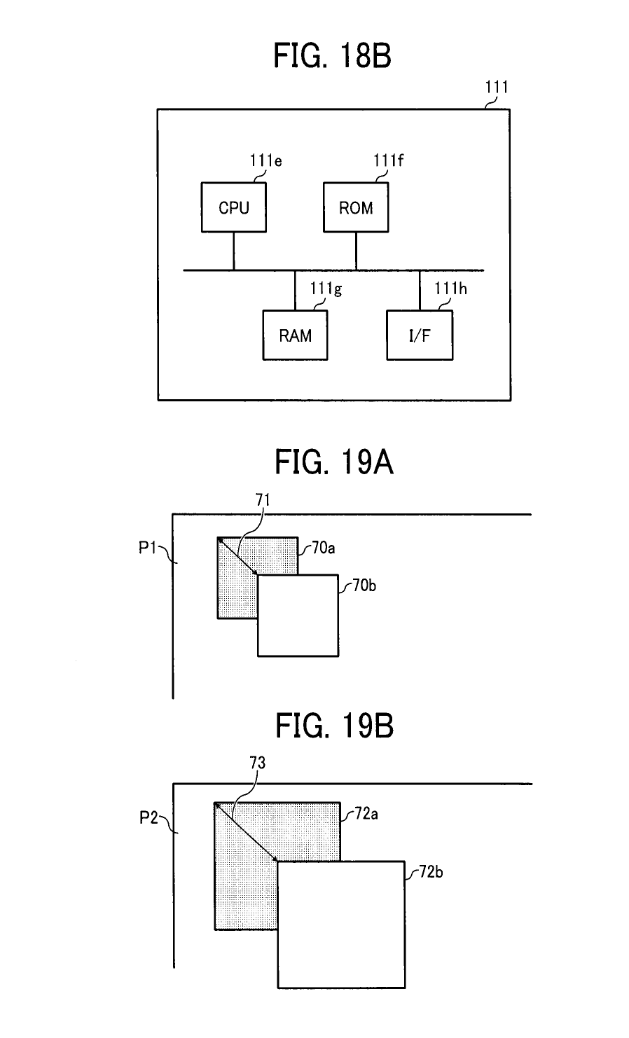

The external I/F 9 includes one or more connection terminals connectable to apparatuses such as a personal computer (PC) and a digital camera, receives image data transmitted from a connected apparatus such as an image processing apparatus 110 shown in FIG. 18, and outputs the image data to the system controller 10.

As to the image projection apparatus 1, the external I/F 9 includes image input terminals such as HDMI (High-Definition Multimedia Interface: registered trademark) terminal, DisplayPort terminal, Thunderbolt terminal, VGA (Video Graphics Array) input terminal, S-VIDEO terminal, and RCA terminal. Further, the image projection apparatus 1 can receive image signals from the image processing apparatus 110 wirelessly by using wireless communication protocol such as Bluetooth (registered trademark) and WiFi (registered trademark).

The system controller 10 includes, for example, an image controller 11, a movement controller 12, and a light source controller 13. As illustrated in FIG. 2B, the system controller 10 has a hardware configuration including, for example, a central processing unit (CPU) 10a, a read only memory (ROM) 10b, a random access memory (RAM) 10c, and an interface (I/F) 10d. When the CPU 10a executes programs stored in the ROM 10b by using the RAM 10c, each units of the image projection apparatus 1 can be devised.

Based on image data input from the external I/F 9, the image controller 11 controls a digital micro mirror device (DMD) 551 disposed in the image generation unit 50 of the optical engine 15 to generate an image to be projected on the screen S.

The movement controller 12 can move the moveable unit 55 disposed moveably in the image generation unit 50 to control a position of the DMD 551 disposed in the moveable unit 55. The movement controller 12 controls a pixel shift amount (or shift amount), shift cycle, and shift direction of the DMD 551.

The light source controller 13 controls power supply to the light source 30 to control an output level of the light source 30.

The cooling unit 20 such as a fan is rotated under a control of the system controller 10 to cool a light source 30 of the optical engine 15.

The optical engine 15 includes, for example, a light source 30, a light guiding unit 40, an image generation unit 50, and an image projection unit 60. The system controller 10 controls the optical engine 15 to project an image on the screen S.

The light source 30 is, for example, a high pressure mercury lamp, a xenon lamp, and a light emitting diode (LED) that emits light to the light guiding unit 40.

The light guiding unit 40 includes, for example, a color wheel, a light tunnel, and a relay lens. The light guiding unit 40 guides the light emitted from the light source 30 to the DMD 551 disposed in the image generation unit 50.

The image generation unit 50 includes, for example, a fixed unit 51 fixed at a given position, and a moveable unit 55 moveably disposed relative to the fixed unit 51. The moveable unit 55 includes, for example, the DMD 551. The movement controller 12 of the system controller 10 controls a position of the DMD 551 relative to the fixed unit 51. The DMD 551 is an example of the light modulation device. The DMD 551 is controlled by the image controller 11 of the system controller 10, and the DMD 551 modulates the light guided by the light guiding unit 40 to generate a projection image.

The image projection unit 60 includes, for example, a plurality of projection lenses and mirrors. The image projection unit 60 projects the image generated by the DMD 551 of the image generation unit 50 onto the screen S.

### (Configuration of Optical Engine)

A description is given of an internal configuration of the optical engine 15 of the image projection apparatus 1.

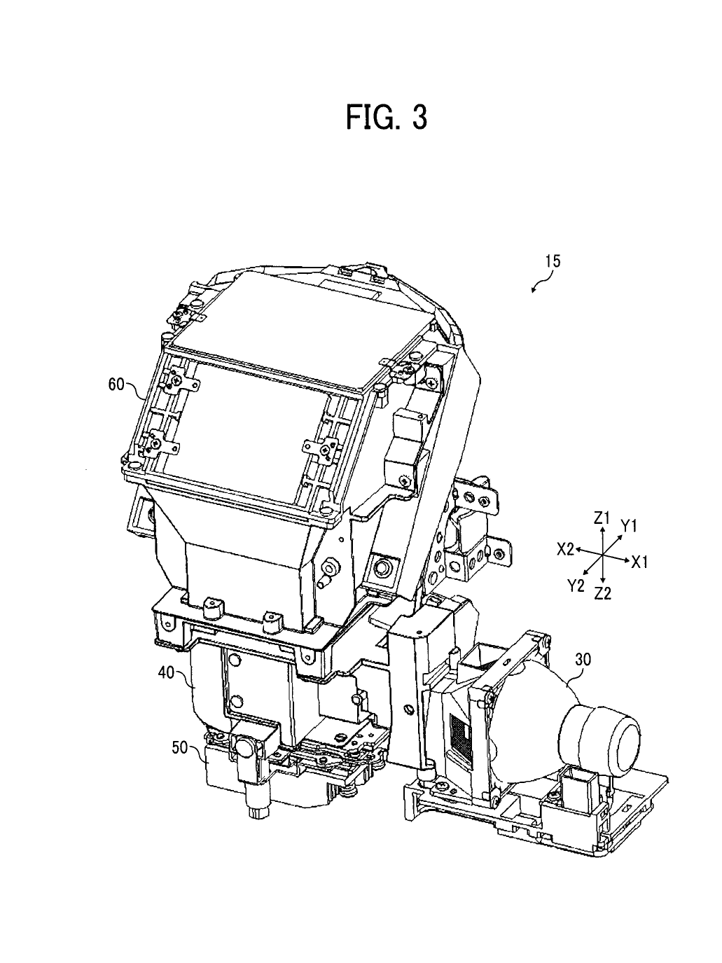

FIG. 3 is a schematic perspective view of the optical engine 15. As illustrated in FIG. 3, the optical engine 15 includes, for example, the light source 30, the light guiding unit 40, the image generation unit 50, and the image projection unit 60. The optical engine 15 is disposed inside the image projection apparatus 1.

The light source 30 is disposed at one side of the light guiding unit 40, and emits light in X2 direction. The light guiding unit 40 guides the light emitted from the light source 30 to the image generation unit 50 disposed under the light guiding unit 40. The image generation unit 50 generates a projection image by using the light guided by the light guiding unit 40. The image projection unit 60, disposed above the light guiding unit 40, projects the projection image generated by the image generation unit 50 to outside the image projection apparatus 1.

The optical engine 15 projects the projection image to the upward by using the light emitted from the light source 30, but the optical engine 15 can be configured to project the projection image to the horizontal direction.

### (Light Guiding Unit)

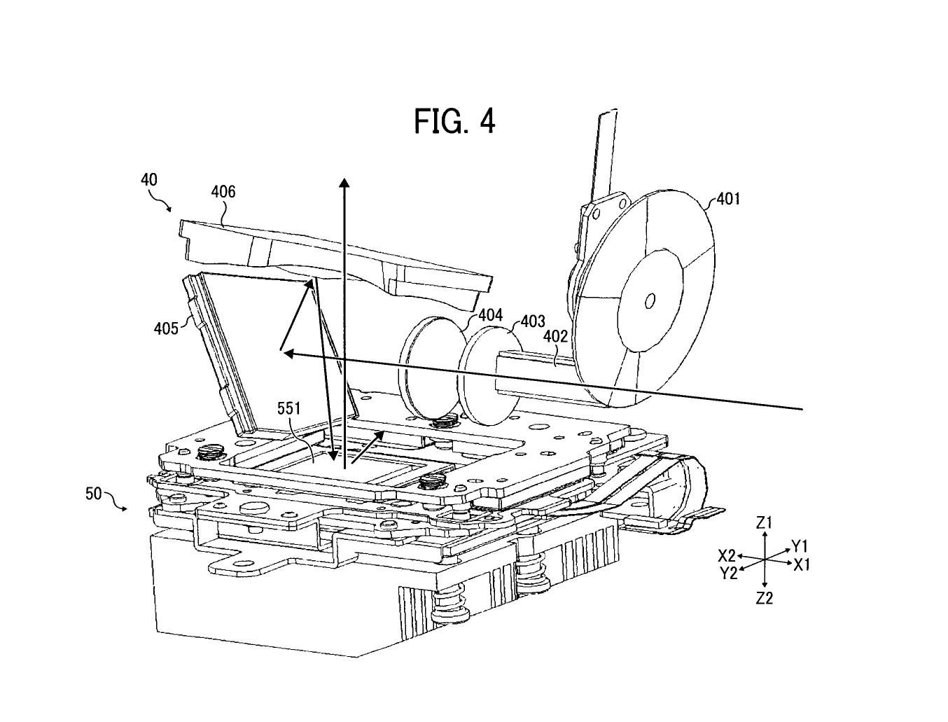

FIG. 4 is a schematic internal perspective view of the light guiding unit 40. As illustrated in FIG. 4, the light guiding unit 40 includes, for example, a color wheel 401, a light tunnel 402, relay lenses 403 and 404, a flat-face mirror 405, and a concave-face mirror 406.

The color wheel 401 is a disk having filters of red, green and blue (R, G, and B) at different parts of the periphery of the disk. The color wheel 401 rotates at a high speed to sequentially separate the light emitted from the light source 30 to RGB light time-divisionally

The light tunnel 402 has a cylindrical shape composed of glass plates. The light tunnel 402 reflects the RGB light coming from the color wheel 401 in the inner face of the light tunnel 402 for multiple times to equalize the intensity profile of the light, and guides the light to the relay lenses 403 and 404.

The relay lenses 403 and 404 condense the light while correcting chromatic aberration on the optical axis of the light coming from the light tunnel 402.

The flat-face mirror 405 and the concave-face mirror 406 reflect the light coming from the relay lenses 403 and 404 to the DMD 551 disposed in the image generation unit 50. The DMD 551 modulates the light reflected from the concave-face mirror 406 to generate a projection image.

### (Image Projection Unit)

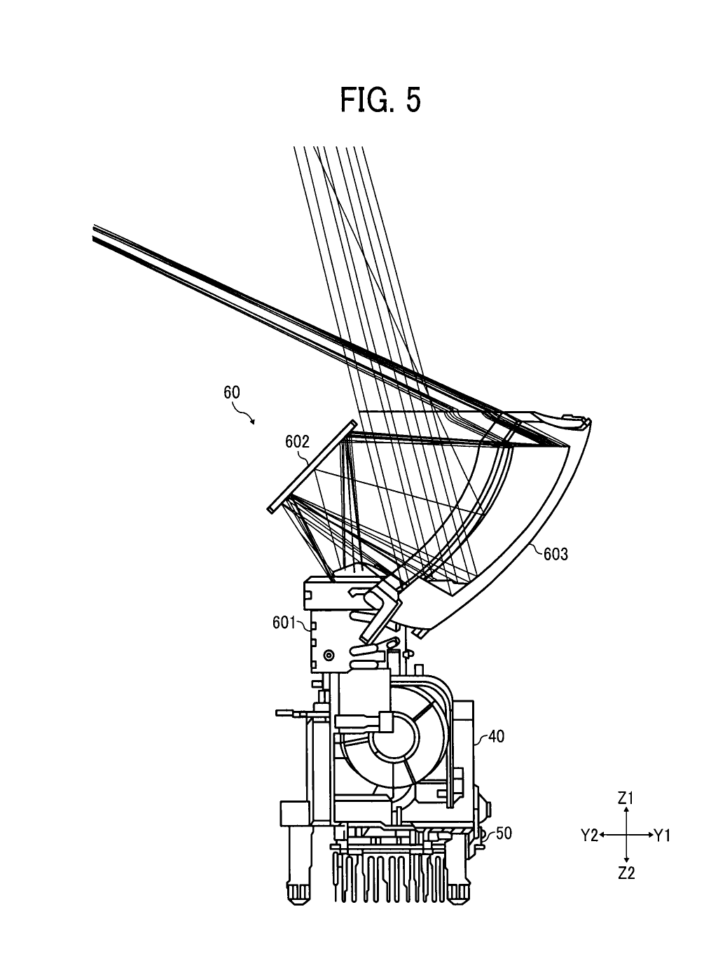

FIG. 5 is a schematic internal perspective view of the image projection unit 60. As illustrated in FIG. 5, the image projection unit 60 includes, for example, a projection lens unit 601, a reflection mirror 602, and a curve mirror 603 in a casing.

The projection lens unit 601 includes a plurality of lenses to focus the projection image generated by the DMD 551 of the image generation unit 50 on the reflection mirror 602. The reflection mirror 602 and the curve mirror 603 enlarges and reflects the focused projection image, and projects the projection image onto the screen S, which is outside the image projection apparatus 1.

### (Image Generation Unit)

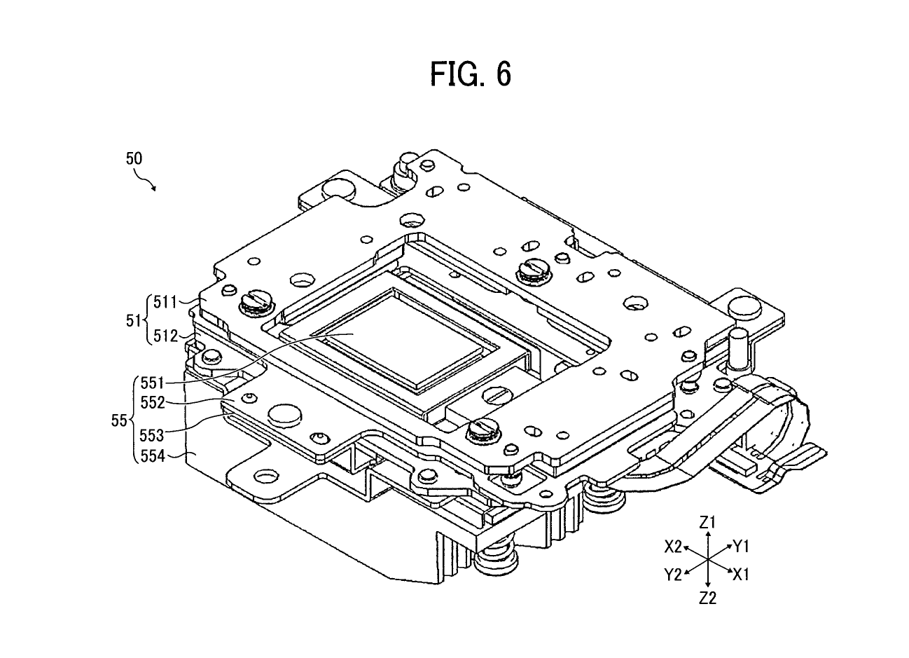

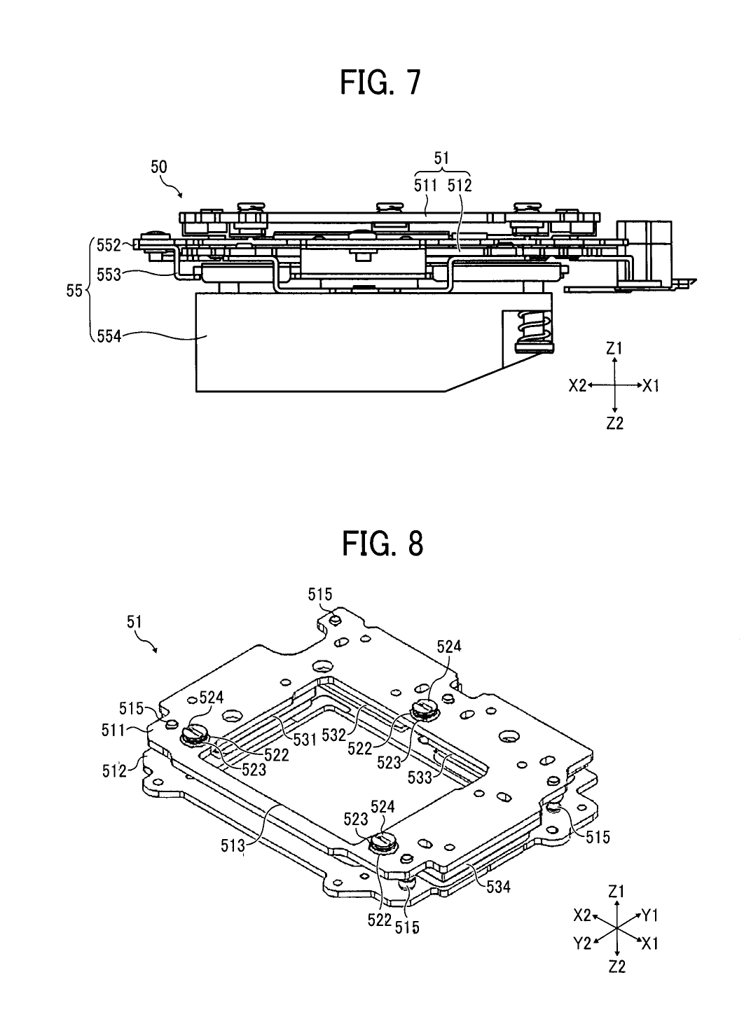

FIG. 6 is a schematic perspective view of the image generation unit 50. Further, FIG. 7 is a schematic side view of the image generation unit 50.

As illustrated in FIGS. 6 and 7, the image generation unit 50 includes, for example, the fixed unit 51 fixed at a given position, and the moveable unit 55 disposed moveably relative to the fixed unit 51.

The fixed unit 51 includes, for example, a top plate 511 as a first fixed plate, and a base plate 512 as a second fixed plate. As to the fixed unit 51, the top plate 511 and the base plate 512 are disposed in the parallel direction with setting a given space therebetween, and the fixed unit 51 is fixed under the light guiding unit 40.

The moveable unit 55 includes, for example, the DMD 551, a moveable plate 552 as a first moveable plate, a coupling plate 553 as a second moveable plate, and a heat sink 554. The moveable unit 55 is moveably supported by the fixed unit 51.

The moveable plate 552 is disposed between the top plate 511 and the base plate 512 of the fixed unit 51, and thereby the moveable plate 552 is d disposed parallel to the top plate 511 and the base plate 512. Further, the moveable plate 552 is moveably supported by the top plate 511 and the base plate 512 in a direction parallel to the faces of top plate 511 and the base plate 512.

The coupling plate 553 is fixed to the moveable plate 552 by interposing the base plate 512 of the fixed unit 51 between the moveable plate 552 and the coupling plate 553. The DMD 551 is fixed on the upper face of the coupling plate 553, and the heat sink 554 fixed on the lower face of the coupling plate 553. By fixing the coupling plate 553 to the moveable plate 552, the coupling plate 553, the moveable plate 552, the DMD 551, and the heat sink 554 are collectively and moveably supported by the fixed unit 51.

The DMD 551 is disposed at one face of the coupling plate 553 facing the moveable plate 552. The DMD 551, the moveable plate 552, and the coupling plate 553 are collectively and moveably disposed. The DMD 551 includes an image generation face composed of a plurality of moveable micro mirrors arranged in a matrix. Each of the micro mirror of the DMD 551 is disposed moveably about a torsion axis of the mirror (i.e., each micro mirror can swing within a given swing angle range), and each of the micro mirror of the DMD 551 is driven between ON/OFF by image signals transmitted from the image controller 11 of the system controller 10.

For example, when the image signal is ON signal, the swing angle of the micro mirror is controlled to reflect the light coming from the light source 30 to the image projection unit 60. Further, when the image signal is OFF signal, the swing angle of the micro mirror is controlled to reflect the light coming from the light source 30 to a light-OFF plate.

In this configuration, the swing angle of each of the micro mirrors of the DMD 551 is controlled by the image signals transmitted from the image controller 11 to modulate the light emitted from the light source 30 and passing through the light guiding unit 40 to generate a projection image.

The heat sink 554 is an example of a heat dissipater, and at least a part of the heat sink 554 contacts the DMD 551. Since the heat sink 554 and the DMD 551 are both disposed on the coupling plate 553, the heat sink 554 can contact the DMD 551 to cool the DMD 551 effectively and efficiently. With this configuration, the heat sink 554 can suppress the temperature increase of the DMD 551 in the image projection apparatus 1, with which problems such as failed operations and malfunctions caused by the temperature increase of the DMD 551 can be reduced.

### (Fixed Unit)

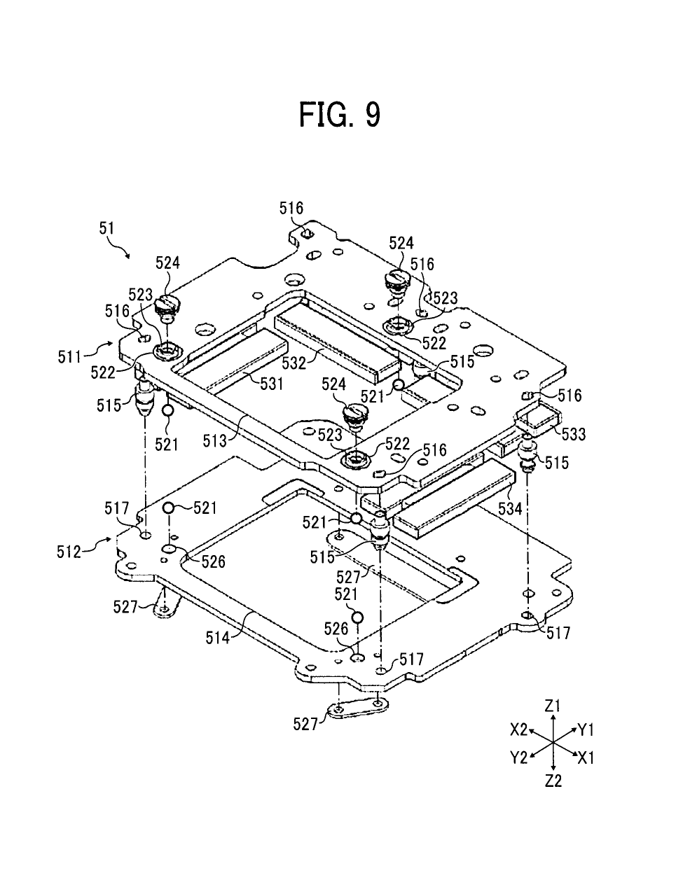

FIG. 8 is a schematic perspective view of the fixed unit 51. Further, FIG. 9 is a schematic perspective view of the disassembled fixed unit 51. As illustrated in FIGS. 8 and 9, the fixed unit 51 includes, for example, the top plate 511 and the base plate 512.

Each of the top plate 511 and the base plate 512 are formed as a flat plate. As illustrated in FIGS. 8 and 9, the top plate 511 has a center through hole 513 at a position corresponding to the DMD 551 of the moveable unit 55, and the base plate 512 has a center through hole 514 at a position corresponding to the DMD 551 of the moveable unit 55. Further, the top plate 511 and the base plate 512 are disposed in parallel by setting a given space therebetween by using a plurality of pillars 515.

As illustrated in FIG. 9, one end of the pillar 515 is pressed into a support hole 516 formed on the top plate 511, and another end of the pillar 515 having male screw grooves is inserted into a support hole 517 formed on the base plate 512. The pillars 515 are used to set the given space between the top plate 511 and the base plate 512, and supports the top plate 511 and the base plate 512 to become parallel with each other.

Further, as illustrated in FIG. 9, the top plate 511 has a plurality of support holes 522, and the base plate 512 has a plurality of support holes 526. The support holes 522 and 526 are used to rotatably hold support balls 521.

As illustrated in FIG. 9, a cylindrical holder 523 having female screw grooves on its inner face is inserted in the support hole 522 of the top plate 511. The cylindrical holder 523 holds the support ball 521 rotatably, and a position adjustment screw 524 is inserted in the top side of the cylindrical holder 523. As illustrated in FIG. 9, the lower end of the support hole 526 formed on the base plate 512 is covered by a cover 527, and the support hole 526 rotatably holds the support ball 521.

Each of the support balls 521, rotatably held by the support holes 522 and 526 respectively formed on the top plate 511 and the base plate 512, contacts the moveable plate 552 disposed between the top plate 511 and the base plate 512, and moveably supports the moveable plate 552.

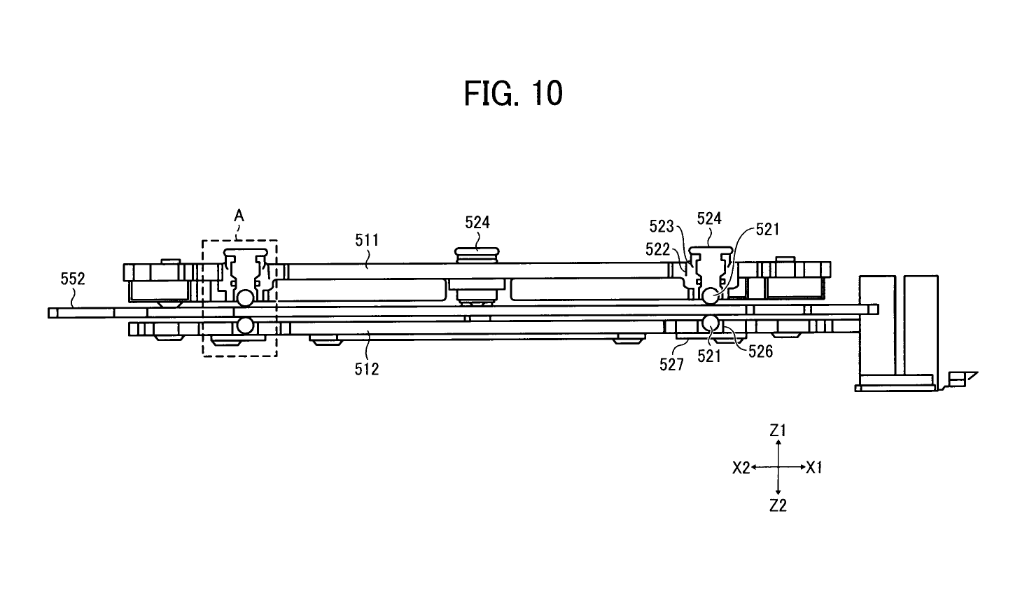

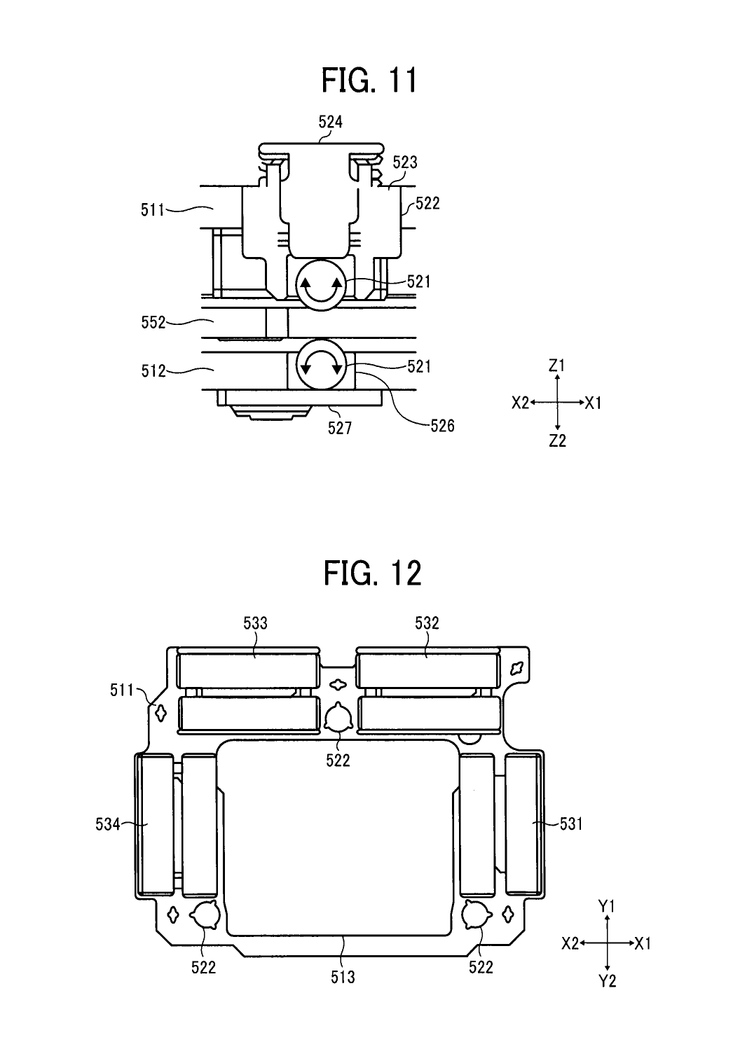

FIG. 10 is a side view of a support structure for the moveable plate 552 supported by the fixed unit 51. Further, FIG. 11 is a partial expanded view of the support structure indicated by “A” in FIG. 10.

As illustrated in FIGS. 10 and 11, at the top plate 511, the cylindrical holder 523 inserted in the support hole 522 rotatably holds the support ball 521. Further, at the base plate 512, the support hole 526 having the lower end covered by the cover 527 rotatably holds the support ball 521.

As illustrated in FIG. 11, a part of the support ball 521 held by the support hole 522 protrudes from the support hole 522, and a part of the support ball 521 held by the support hole 526 protrudes from the hole 526. Therefore, the support ball 521 contacts and supports the moveable plate 552 disposed between the top plate 511 and the base plate 512. With this configuration having the plurality of the support balls 521 disposed rotatably, the moveable plate 552 can be supported by the top plate 511 and the base plate 512 in parallel to the top plate 511 and the base plate 512, and the moveable plate 552 can be moved in a direction parallel to the faces of the top plate 511 and the base plate 512.

Further, as illustrated in FIG. 11, the support ball 521 disposed at the top plate 511 contacts the position adjustment screw 524, which is at a position opposite to the moveable plate 552. When a position of the position adjustment screw 524 is changed, a protrusion length of the support ball 521 from the lower end of the cylindrical holder 523 changes. For example, when the position adjustment screw 524 is moved to Z1 direction, the protrusion length of the support ball 521 decreases, and thereby a space between the top plate 511 and the moveable plate 552 becomes smaller. Further, when the position adjustment screw 524 is moved to Z2 direction, the protrusion length of the support ball 521 increases, and thereby the space between the top plate 511 and the moveable plate 552 becomes greater.

As above described, the space between the top plate 511 and the moveable plate 552 can be adjusted by changing the protrusion length of the support ball 521 by using the position adjustment screw 524.

Further, as illustrated in FIG. 8 and FIG. 9, a plurality of magnets 531, 532, 533, and 534 are disposed on a face of the top plate 511 facing the base plate 512.

FIG. 12 is a bottom view of the top plate 511. As illustrated in FIG. 12, the magnets 531, 532, 533, and 534 are disposed on one face of the top plate 511 facing the base plate 512.

As illustrated in FIG. 12, the magnets 531, 532, 533, and 534 are disposed at four portions around the center through hole 513 of the top plate 511. Each of the magnets 531, 532, 533, and 534 is configured with two rectangular parallelepiped magnets, in which the long side of the two rectangular parallelepiped magnets are disposed in parallel to generate a magnetic field effecting the moveable plate 55.

The magnets 531, 532, 533, and 534 disposed on the top plate 511, and coils disposed on a top face of the moveable plate 552 by counter-facing the magnets 531, 532, 533, and 534 configure a movement unit that can move the moveable plate 552.

The numbers and positions of the pillars 515 and the support balls 521 disposed on the fixed unit 51 that moveably support the moveable plate 552 is not limited to the above described numbers and positions, but the numbers and positions of the pillars 515 and the support balls 521 disposed on the fixed unit 51 can be changed as required.

### (Moveable Unit)

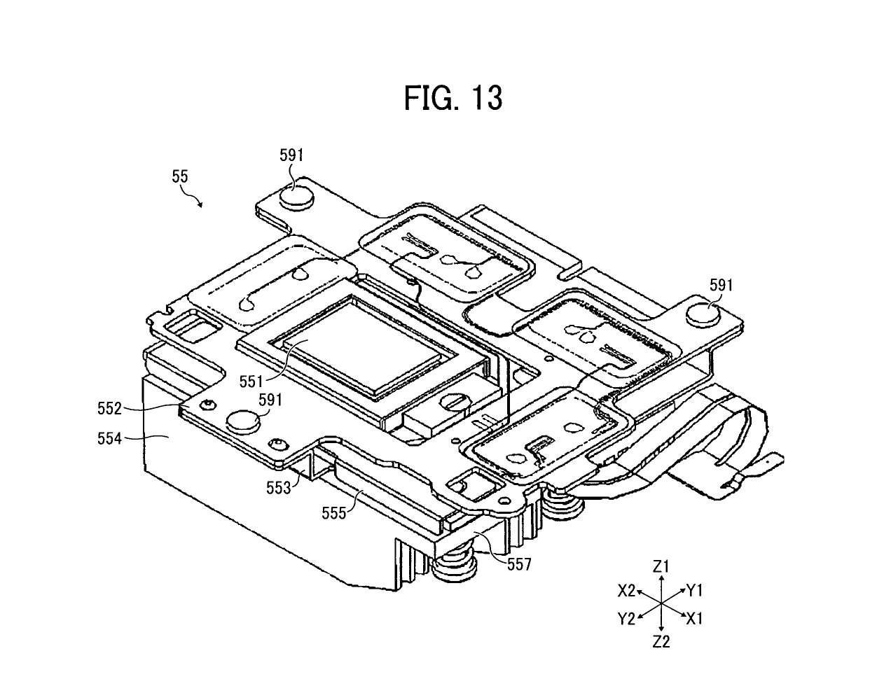

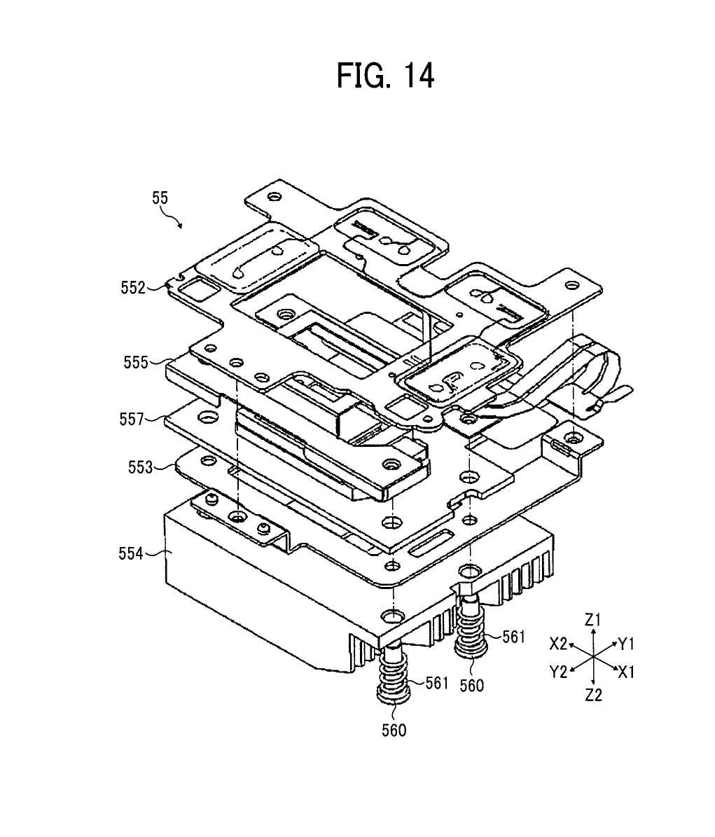

FIG. 13 is a schematic perspective view of the moveable unit 55. Further, FIG. 14 is a schematic perspective view of the disassembled moveable unit 55.

As illustrated in FIGS. 13 and 14, the moveable unit 55 includes, for example, the DMD 551, the moveable plate 552, the coupling plate 553, the heat sink 554, a holder 555, and a DMD board 557. The moveable unit 55 is moveably supported by the fixed unit 51.

As above described, the moveable plate 552 is disposed between the top plate 511 and the base plate 512 of the fixed unit 51, and the moveable plate 552 is moveably supported by the plurality of the support balls 521 to move in the direction parallel to the faces of the top plate 511 and the base plate 512.

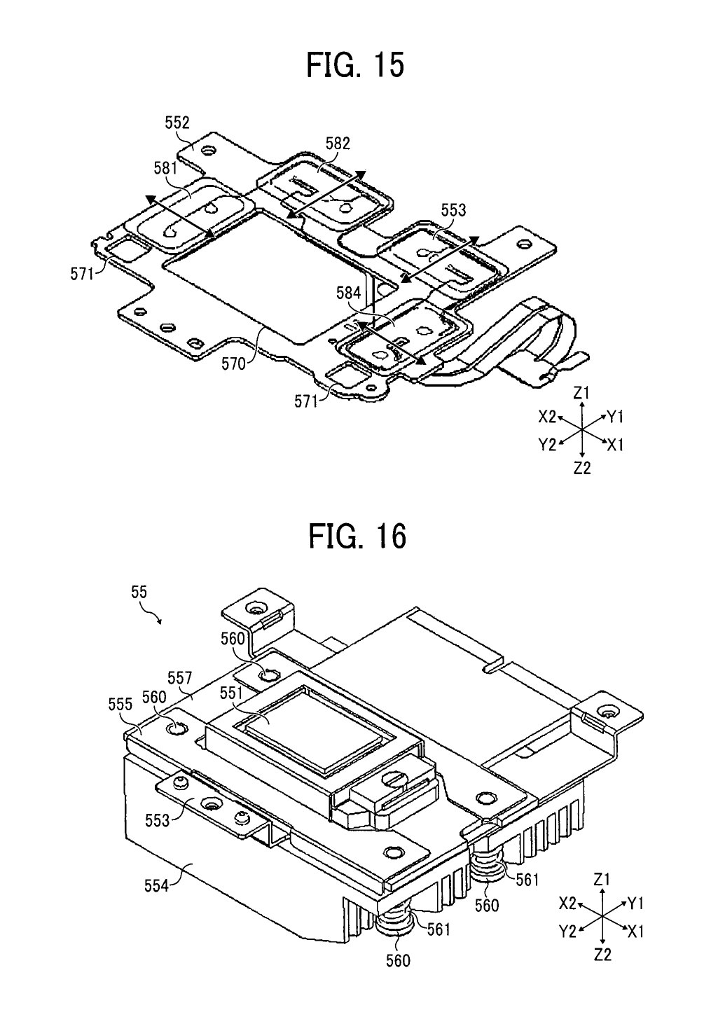

FIG. 15 is a schematic perspective view of the moveable plate 552. As illustrated in FIG. 15, the moveable plate 552 is formed as a flat plate. The moveable plate 552 has a center through hole 570 at a position corresponding to the DMD 551 disposed on the DMD board 557. As illustrated in FIG. 15, a plurality of coils 581, 582, 583, and 584 are disposed at four portions around the center through hole 570.

Each of the coils 581, 582, 583, and 584 can be formed by winding electrical wires about an axis parallel to Z1-Z2 direction, and each of the coils 581, 582, 583, and 584 is disposed in a concave formed on a face of the moveable plate 552 facing the top plate 511, and covered by a cover. The coils 581, 582, 583, and 584 on the moveable plate 552 and the magnets 531,532,533, and 534 on the top plate 511 collectively configure the movement unit that can move the moveable plate 552.

The respective magnets 531, 532, 533, and 534 on the top plate 511 and the respective coils 581, 582, 583, 584 on the moveable plate 552 are disposed at counter-facing positions while the moveable unit 55 is supported by the fixed unit 51. When current flows to the coils 581, 582, 583, and 584, the Lorentz force useable as a driving force to move the moveable plate 552 occurs with the effect of the magnetic field generated by the magnets 531,532,533, and 534.

With the effect of the Lorentz force that occurs as the driving force between the magnets 531,532,533, and 534 and the coils 581, 582, 583, and 584, the moveable plate 552 can shift or move in one direction or in a rotation direction relative to the fixed unit 51 along XY plane.

The movement controller 12 of the system controller 10 controls a level and flow direction of current to be supplied to each of the coils 581, 582, 583, and 584. The movement controller 12 controls a shifting direction such as a movement direction and rotation direction, a shift amount, and a rotation angle of the moveable plate 552 by controlling the level and flow direction of current to be supplied to each of the coils 581, 582, 583, and 584.

The coil 581 and the magnet 531, and the coil 584 and the magnet 534 are disposed at opposite positions along X1-X2 direction as a first driver unit. When current flows to the coils 581 and the coils 584, the Lorentz force along X1 direction or X2 direction occurs as illustrated in FIG. 15. The moveable plate 552 can be moved along X1 direction or X2 direction by the Lorentz force occurring to the coils 581 and the magnet 531, and the coils 584 and the magnet 534.

Further, the coil 582 and the magnet 532, and the coil 583 and the magnet 533 are disposed side by side along X1-X2 direction as a second driver unit. As illustrated in FIG. 12, the long sides of the magnet 532 and the magnet 533, and the long sides of the magnet 531 and the magnet 534 are arranged perpendicular with each other. When current flows to the coil 582 and the coil 583 in this configuration, the Lorentz force occurs along Y1 direction or Y2 direction as illustrated in FIG. 15.

The moveable plate 552 can be moved along Y1 direction or Y2 direction by the Lorentz force occurring at the coil 582 and the magnet 532, and the Lorentz force occurring at the coil 583 and the magnet 533. Further, the moveable plate 552 can be moved in a rotation direction along the XY plane by the Lorentz force occurring at the coil 582 and the magnet 532 in one direction, and the Lorentz force occurring at the coil 583 and the magnet 533 in the opposite direction.

For example, when current flows to the coil 582 and the coil 583 to generate the Lorentz force in Y1 direction at the coil 582 and the magnet 532, and the Lorentz force in Y2 direction at the coil 583 and the magnet 533, the moveable plate 552 can be moved in a direction rotating in the clockwise direction when viewed from the top side. Further, when current flows to the coil 582 and the coil 583 to generate the Lorentz force in Y2 direction at the coil 582 and the magnet 532, and the Lorentz force in Y1 direction at the coil 583 and the magnet 533, the moveable plate 552 can be moved in a direction rotating in the counter-clockwise direction when viewed from the top side.

Further, the moveable plate 552 can be formed with a movement range limiting hole 571 at a position corresponding to the pillar 515 of the fixed unit 51, in which the pillar 515 is inserted in the movement range limiting hole 571. With configuration, when the moveable plate 552 moves too great due to vibration or some abnormalities, the movement range limiting hole 571 contacts the pillar 515 to limit the movement range of the moveable plate 552.

As described above, the movement controller 12 of the system controller 10 controls the level and flow direction of current to be supplied to each of the coils 581, 582, 583, and 584 to move the moveable plate 552 to any positions within the movement range.

The numbers and positions of the magnets 531, 532, 533, and 534 and the coils 581, 582, 583, and 584 used as the movement unit that can move the moveable plate 552 is not limited to the above configuration. For example, the magnets can be disposed on a top face of the top plate 511, or on any faces of the base plate 512. Further, the magnets can be disposed on the moveable plate 552, and the coils can be disposed on the top plate 511 or the base plate 512.

Further, the numbers, positions, and shape of the movement range limiting hole 571 is not limited to the above configuration. For example, the movement range limiting hole 571 can be disposed with one holes or a plurality of holes. Further, the shape of the movement range limiting hole 571 can be any shapes such as rectangular, circle, or the like.

As illustrated in FIG. 13, the coupling plate 553 is fixed to the lower side face of the moveable plate 552 (i.e., face facing the base plate 512) moveably supported by the fixed unit 51. The coupling plate 553 is formed as a flat plate, and has a center through hole at a position corresponding to the DMD 551. Three folded portions disposed at the periphery of the coupling plate 553 are fixed to the lower side face of the moveable plate 552 by using three screws 591.

FIG. 16 is a schematic perspective view of the moveable unit 55 removing the moveable plate 552. As illustrated in FIG. 16, the DMD 551 is disposed on the top face side of the coupling plate 553, and the heat sink 554 is disposed on the bottom face side of the coupling plate 553. By fixing the coupling plate 553 to the moveable plate 552, the coupling plate 553 having the DMD 551 and the heat sink 554, and the moveable plate 552 are collectively moveably disposed relative to the fixed unit 51.

The DMD 551 is disposed on the DMD board 557, and the DMD board 557 is sandwiched by the holder 555 and the coupling plate 553, with which the DMD 551 disposed on the DMD board 557 is fixed to the coupling plate 553. As illustrated in FIG. 14 and FIG. 16, the holder 555, the DMD board 557, the coupling plate 553, and the heat sink 554 are stacked and fixed by screws 560 used as fixing members and springs 561 used as pressure members.

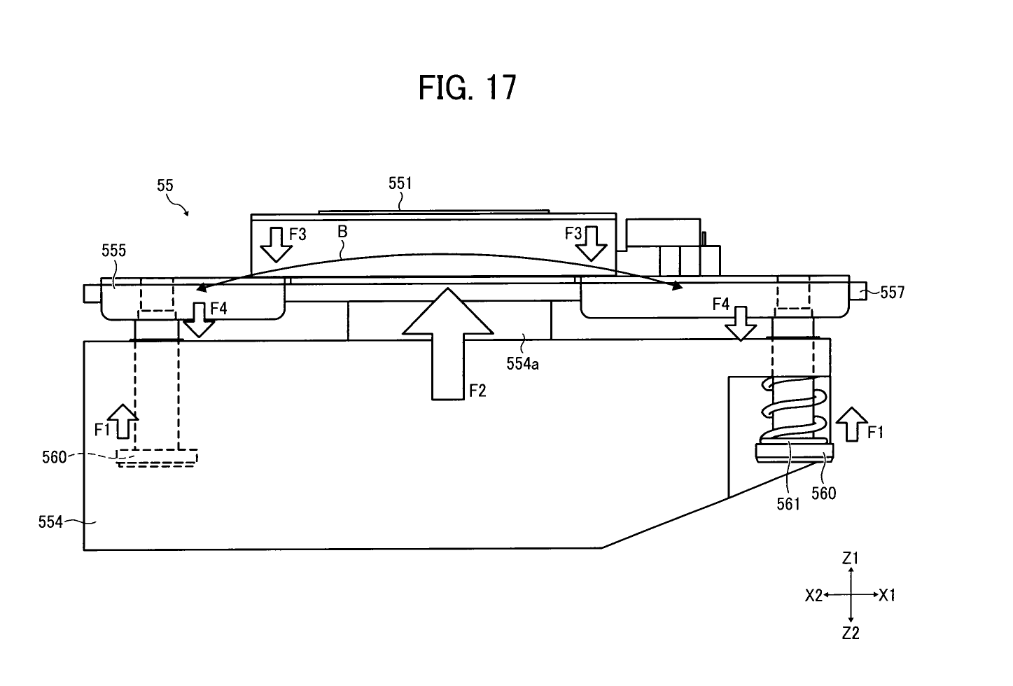

FIG. 17 is a side view of a DMD holding configuration set for the moveable unit 55. FIG. 17 is a schematic side view of the moveable unit 55, in which the moveable plate 552 and the coupling plate 553 are omitted.

As illustrated in FIG. 17, the heat sink 554 includes, for example, a protrusion 554a that protrudes a through hole disposed for the DMD board 557 and contacts the bottom face of the DMD 551 while the heat sink 554 is fixed to the coupling plate 553. Further, the protrusion 554a of the heat sink 554 can be configured to contact the bottom face of the DMD board 557 corresponding to the position of the DMD 551.

Further, a deformable elastic heat conductive sheet can be disposed between the protrusion 554a of the heat sink 554 and the DMD 551 to enhance the cooling effect of the DMD 551. The heat conductivity between the protrusion 554a of the heat sink 554 and the DMD 551 can be increased by disposing the heat conductive sheet, with which the cooling effect of the heat sink 554 to the DMD 551 can be enhanced.

As illustrated in FIG. 17, the holder 555, the DMD board 557, and the heat sink 554 are stacked and fixed by the screws 560 and the springs 561. When the screws 560 is screwed to Z1 direction, the springs 561 is compressed in Z1-Z2 direction, and a force F1 in Z1 direction occurs to the spring 56 as illustrated in FIG. 17. With the effect of the force F1 occurred to the spring 561, the heat sink 554 is pressed to the DMD 551 with a force F2 in Z1 direction.

In this configuration, the screws 560 and the springs 561 are disposed at four positions. Therefore, the force F2 occurred to the heat sink 554 is equal to the force synthesizing the force F1 occurred to the four springs 561. Further, the force F2 occurred to the heat sink 554 effects the holder 555 holding the DMD board 557 disposed with the DMD 551. Therefore, counterforce F3 in Z2 direction, matched to the force F2 from the heat sink 554, occurs to the holder 555, with which the DMD board 557 can be held between the holder 555 and the coupling plate 553.

The counterforce F 3 occurred to the holder 555 generates the force F4 in Z2 direction that effects the screws 560 and the springs 561. Since the springs 561 are disposed at four positions, the force F4 effecting each of the springs 561 is equal to one fourth of the counterforce F3 occurred to the holder 555. Therefore, the force F4 matches the force F1.

Further, the holder 555 can be a made of a spring plate that can warp as indicated by an arrow B in FIG. 17. The holder 555 warps when the protrusion 554a of the heat sink 554 presses the holder 555 in Z1 direction, and then a force to press back to the heat sink 554 in Z2 direction occurs, with which the DMD 551 and the heat sink 554 can be contacted securely.

As described above, the moveable unit 55 includes, for example, the moveable plate 552, and the coupling plate 553 disposed with the DMD 551 and the heat sink 554, and the moveable unit 55 is moveably supported by the fixed unit 51. The position of the moveable unit 55 can be controlled by the movement controller 12 of the system controller 10. Further, the heat sink 554 that contacts the DMD 551 is disposed for the moveable unit 55, with which problems such as failed operations and malfunctions caused by the temperature increase of the DMD 551 can be reduced, in particular prevented.

### (Image Projection)

As described above, as to the above described image projection apparatus 1, the DMD 551 to generate a projection image is disposed in the moveable unit 55, and thereby the position of the DMD 551 and the moveable unit 55 can be controlled by the movement controller 12 of the system controller 10.

For example, the movement controller 12 controls positions of the moveable unit 55 with a given cycle matched to a frame rate used for projecting images. For example, the movement controller 12 controls the moveable unit 55 between a plurality of positions which are apart with each other with a distance smaller than the arrangement pitch of the adjacent micro mirrors of the DMD 551 with a high speed, in which the image controller 11 transmits image signals to the DMD 551 to generate projection images processed with the shifting in view of each of the positions of the moveable unit 55.

For example, the movement controller 12 moves the DMD 551 between a position P1 and a position P2 distanced with each other with a distance smaller than the arrangement pitch of the adjacent micro mirrors of the DMD 551 in X1-X2 direction and Y1-Y2 direction with the given cycle. In this case, the image controller 11 controls the DMD 551 to generate projection images processed with the shifting in view of each of the positions of the DMD 551, with which the resolution of the projection image can be increased to about two times of the resolution of the DMD 551. Further, the resolution of the projection image can be increased to about two times or more of the resolution of the DMD 551 by increasing the number of moved positions of the DMD 551.

By moving the moveable unit 55 and the DMD 551 with the given cycle under the control of the movement controller 12, and generating the projection image corresponding to the positions of the DMD 551 under the control of the image controller 11, images can be projected with a resolution greater than the resolution of the DMD 551.

Further, as to the image projection apparatus 1, the movement controller 12 can control both of the DMD 551 and the moveable unit 55 to rotate both of the DMD 551 and the moveable unit 55, with which a projection image can be rotated without reducing the size. For example, as to conventional projectors that the light modulation device such as the DMD 551 is fixed, a projection image can be rotated while maintaining the aspect ratio of the projection image only when the size of the projection image is reduced. By contrast, as to the image projection apparatus 1 of one or more example embodiments, the DMD 551 can be rotated as described above. Therefore, the adjustment of inclination can be performed while the projection image is rotated without reducing the size of the projection image.

As to the above described image projection apparatus 1, the DMD 551 is configured moveably, by which the higher resolution can be attained for the projection images. Further, since the heat sink 554 that contacts and cools the DMD 551 is disposed with the DMD 55 for the moveable unit 55, the DMD 551 can be cooled efficiently and thereby the temperature increase of the DMD 551 can be suppressed. Therefore, problems such as failed operations and malfunctions caused by the temperature increase of the DMD 551 can be reduced, in particular prevented for the image projection apparatus 1.

As to the above described image projection apparatus 1, an image is generated and projected onto the screen S by setting the angle of each of the micro mirrors the DMD 551 used as the light modulation device. Therefore, when the DMD 55 is moved or shifted in a translational direction or in a rotating direction while maintaining the angle of each one of the micro mirrors, projection positions of the projection images are moved or shifted while maintaining the image information projected onto the screen S.

For example, when the DMD 551 is moved or shifted for a half pixel with a given cycle, images projected on the screen S is moved or shifted for the half pixel with the given cycle, with which an intermediate image is formed on the screen S, and pixel numbers and pixel density in appearance can be increased. Therefore, images can be formed on the screen S with the pixel numbers greater than the pixel numbers set for the DMD 551, with which the images having a resolution higher than the pixel numbers set for the DMD 551 can be projected on the screen S virtually.

The pixel shift mechanism employed for the image projection apparatus 1 is not limited to the above configuration described with reference to FIG. 6 to FIG. 17. Any pixel shift mechanisms that moves the DMD 551 for shifting the projection position while maintaining the image information projected onto the screen can be employed.

### (Image Projection System and Image Processing Apparatus)

A description is given of an image projection system 100, which is also referred to a multi-projection system 100, of one or more example embodiments of the present invention. The image projection system 100 can be configured with a plurality of image projection apparatuses having the above described pixel shift mechanism, and an image processing apparatus employed for the image projection system 100.

The image projection system 100 (multi-projection system 100) includes an image processing apparatus (image processing apparatus 110), and a plurality of image projection apparatuses (image projection apparatuses 1). The image projection system 100 projects a plurality of projection images (first projection image P1 and second projection image P2) from a plurality of image projection apparatuses (image projection apparatuses 1A, 1B) by overlapping a part of one projection image and a part of another projection image at an overlapping area (overlapping area SI) of the adjacent projection images. The image processing apparatus (image processing apparatus 110) includes, for example, a shift amount calculator (shift amount calculator 111A), a shift amount adjuster (shift amount adjuster 111B), and a shift amount output unit (shift amount output unit 115).

When a shift control of the light modulation device (DMD 551) is performed by moving the light modulation device with a given cycle in the plurality of image projection apparatuses, the shift amount calculator (shift amount calculator 111A) calculates a pixel shift amount of a projection image projected by each of the plurality of image projection apparatuses on a projection face. The shift amount adjuster (shift amount adjuster 111B) calculates a deviation amount of pixel shift amount between the plurality of image projection apparatuses, and calculates a corrected shift amount to set the pixel shift amount between the plurality of image projection apparatuses as the same pixel shift amount, or a corrected shift amount to reduce the deviation amount. The shift amount output unit (shift amount output unit 115) transmits the corrected shift amount to one or more image projection apparatuses that require correction of the pixel shift amount among the plurality of image projection apparatuses.

### (Configuration of Image Projection System)

FIG. 18A is an example configuration of the multi-projection system 100, and a functional block diagram of the image processing apparatus of the multi-projection system 100.

As illustrated in FIG. 18A, the multi-projection system 100 is used to project a plurality of images onto a projection face PF such as a screen or wall. The multi-projection system 100 includes, for example, a first image projection apparatus 1A, a second image projection apparatus 1B, an image processing apparatus 110, and an image capture device 120. The first image projection apparatus 1A projects a first projection image P1 on the projection face PF. The second image projection apparatus 1B projects a second projection image P2 on the projection face PF. The image processing apparatus 110 supplies image data to the first mage projection apparatus 1A and the second image projection apparatus 1B. The image capture device 120 captures the projection images projected onto the projection face PF from the first mage projection apparatus 1A and the second image projection apparatus 1B. Further, the first projection image P1 and the second projection image P2 are projected by setting an overlapping area SI between the first projection image P1 and the second projection image P2.

As illustrated in FIG. 18A, the image processing apparatus 110 includes, for example, a control unit 111 having a shift amount calculator 111A and a shift amount adjuster 111B, a captured data receiver 112, an image data input unit 113, an operation unit 114, a shift amount output unit 115, an image output unit 116, a test image output unit 117, and a storage 118. The image processing apparatus 110 is, for example, a note book PC, a desktop PC, a tablet PC that can supply image signals.

The image processing apparatus 110 and the external I/F 9 of each of the first and second image projection apparatuses 1A and 1B can be coupled by a given communication interface.

The image capture device 120 is a camera that captures test pattern images and projection images projected from the first and second image projection apparatuses 1A and 1B. The image capture device 120 can be disposed outside of the first and second image projection apparatuses 1A and 1B, or the image capture device 120 can be disposed in each of the first and second image projection apparatuses 1A and 1B as required.

As illustrated in FIG. 18B, the control unit 111 has a hardware configuration including, for example, a central processing unit (CPU) 111e used as a main processor, a read only memory (ROM) 111f that stores control programs, and a random access memory (RAM) 111g such as synchronous dynamic random access memory (SDRAM) that stores data and settings for processing, and an interface (I/F) 111f, which are connected by a bus. When the CPU 111e executes programs stored in the ROM 111f by using the RAM 111g, each units of the control unit 111 can be devised.

When image data is input to the image data input unit 113, the control unit 111 divides the image data to first image data to be projected by the first image projection apparatus 1A, and second image data to be projected by the second image projection apparatus 1B, and performs optimization of the overlapping area SI where the divided two images are overlapped by controlling the intensity or the like.

Further, the control unit 111 includes the shift amount calculator 111A and the shift amount adjuster 111B. The shift amount calculator 111A and the shift amount adjuster 111B adjusts a shift amount between the first and second image projection apparatuses 1A and 1B. The shift amount, shift cycle, shift direction of the light modulation device (DMD 551) is controlled by the movement controller 12 disposed in each of the first and second image projection apparatuses 1A and 1B.

When the movement controller 12 of the first image projection apparatus 1A and the movement controller 12 of the second image projection apparatus 1B perform a shift control that moves the light modulation device with a given cycle, the shift amount calculator 111A calculates a pixel shift amount for each of the first projection image P1 and the second projection image P2 on the projection face PF, which is a pixel shift amount in appearance.

The shift amount adjuster 111B calculates a deviation amount for the pixel shift amount calculated by the shift amount calculator 111A, and calculates a corrected shift amount so that the pixel shift amount between the image projection apparatuses 1A and 1B becomes the same pixel shift amount, or the deviation amount of the pixel shift amount can decreased in appearance.

The captured data receiver 112 is input with captured image data such as a test pattern image captured by the image capture device 120, and a projection image embedded with the test pattern image captured by the image capture device 120.

The image data input unit 113 is input with image data to be projected by the image projection apparatuses 1A and 1B. The image data can be stored in the storage 118.

The operation unit 114 includes buttons and keys used for receiving various operations by a user. For example, the operation unit 114 can be disposed on one face of the image processing apparatus 110. When the operation unit 114 receives operations requested by the user, the operation unit 114 transmits the requested operations to the control unit 111.

The shift amount output unit 115 outputs a shift amount such as a corrected shift amount calculated by the shift amount adjuster 111B of the control unit 111 to a projector that requires correction of the shift amount.

The image output unit 116 outputs the images processed by the control unit 111 to the corresponding image projection apparatuses 1A and 1B.

Tithe image output unit 116 includes interfaces such as image output terminals including HDMI (High-Definition Multimedia Interface: registered trademark) terminal, DisplayPort terminal, Thunderbolt terminal, VGA (Video Graphics Array) output terminal, S-VIDEO terminal, and RCA terminal to output image signals. Further, the image processing apparatus 110 can transmit image signals to the image projection apparatus 1 using wireless communication. For example, the image output unit 116 transmits image signals for generating display images to the image projection apparatus 1 with a given transfer rate such as 30 fps (frames per second) to 60 fps (frames per second).

The test image output unit 117 transmits the test pattern image stored in the storage 118 to the first and second image projection apparatuses 1A and 1B.

The storage 118 is a non-volatile memory such as NVRAM (Non Volatile RAM), and hard disk drive that stores the test pattern image and image data for projection.

### (Processing of Image Projection System)

As to the multi-projection system 100, before the image projection apparatuses 1A and 1B project projection images, the image projection apparatuses 1A and 1B project a test pattern image to calculate the shift amount of the light modulation device as a projection condition setting step of the multi-projection.

Then, the image capture device 120 captures the test pattern image projected from the image projection apparatuses 1A and 1B. The captured data receiver 112 receives the image data of the test pattern image captured by the image capture device 120. Then, the shift amount calculator 111A and the shift amount adjuster 111B calculate the corrected shift amount of the light modulation device. The corrected shift amount (i.e., calculated result) is transmitted to the image projection apparatuses 1A and 1B via the shift amount output unit 115, and then the movement controller 12 applies the corrected shift amount for controlling the light modulation device.

The projection instruction of the test pattern image, and the calculation instruction of the test pattern image input from the image capture device 120 can be instructed by using the operation unit 114.

When the projection distances of the image projection apparatuses 1A and 1B to the screen are set as the same distance, the shift amount of the light modulation devices of the image projection apparatuses 1A and 1B can become the same value theoretically. However, when some differences occurs to the distances, a shift amount per one pixel becomes different between two projection images having higher resolution in appearance. Therefore, the shift amount of the light modulation device is required to be adjusted.

### (Adjustment of Shift Amount)

FIG. 19 is an example of a test pattern image projected from the image projection apparatus 1. The test pattern image can be a dot pattern image but not limited hereto.

FIG. 19A illustrates the first projection image P1 projected from the first image projection apparatus 1A, in which positions of a pixel 70 in the test pattern image are shown. Specifically, FIG. 19A illustrates a position of a pixel 70a before the shifting, and a position of a pixel 70b after the shifting. The position of the pixel 70 shifts from the pixel 70a to the pixel 70b when the light modulation device is moved with a given shift amount to a given direction with the given cycle. A length of an arrow 71 in FIG. 19A indicates a pixel shift amount between the pixel 70a and the pixel 70b.

Further, FIG. 19B illustrates the second projection image P2 projected from the second image projection apparatus 1B, in which positions of a pixel 72 in the test pattern image is shown. Specifically, FIG. 19B illustrates a position of a pixel 72a before the shifting, and a position of a pixel 72b after the shifting. The position of the pixel 72 shifts from the pixel 72a to the pixel 72b when the light modulation device is moved with a given shift amount to a given direction with the given cycle. A length of an arrow 73 in FIG. 19B indicates a pixel shift amount between the pixel 72a and the pixel 72b.

FIGS. 19A and 19B illustrate a case that difference of the projection distance between the first image projection apparatus 1A and the second image projection apparatus 1B is relatively great. Therefore, the difference of the shift amount of one pixel indicated by the arrow 71 and the shift amount of one pixel indicated by the arrow 73 becomes relatively great.

If the multi-projection is performed without correcting the shift amount shown in FIGS. 19A and 19B, visual perception at the overlapping area or image stitching portion of the adjacent projection images degrades. Therefore, in one or more example embodiments of the present invention, based on the difference of shift amount of one pixel (i.e., difference of the arrow 71 and the arrow 73), the control unit 111 of the image processing apparatus 110 adjusts or converts the shift amount of the first image projection apparatus 1A and the shift amount of the second image projection apparatus 1B to the same level shift amount to correct the difference of the shift amount of the first image projection apparatus 1A and the shift amount of the second image projection apparatus 1B. The correction is performed to the shift amount without changing the shift cycle and shift direction of the light modulation device.

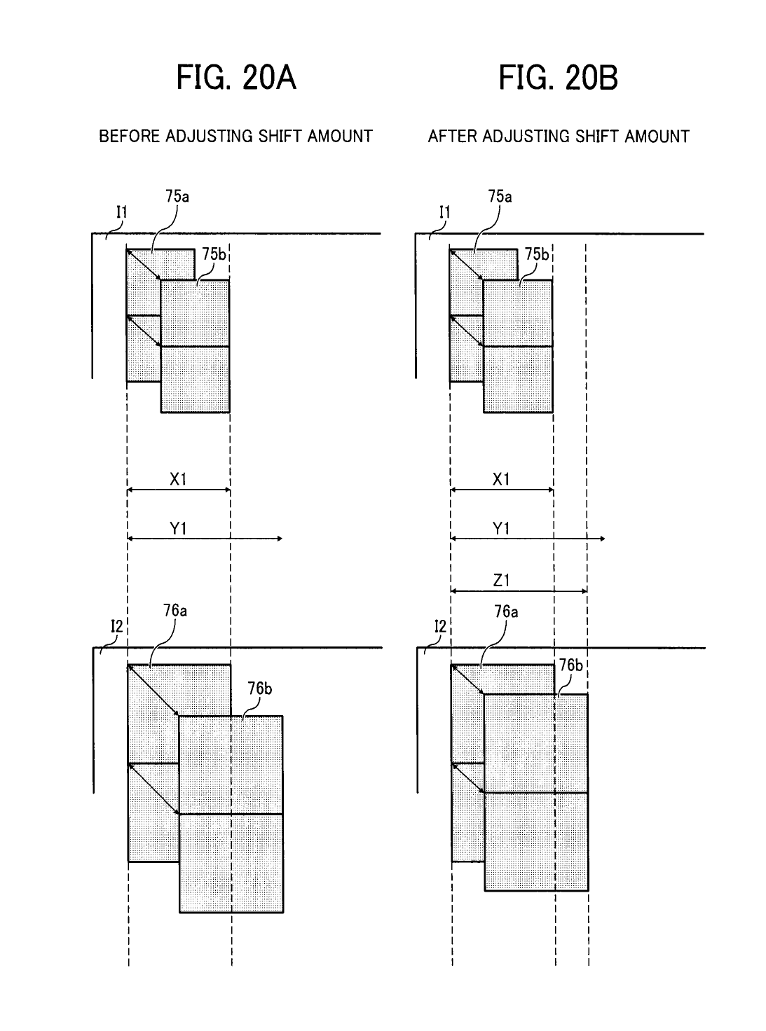

FIG. 20 illustrates a scheme of adjustment of the shift amount of the light modulation device. The shift amount calculator 111A and the shift amount adjuster 111B of the control unit 111 calculate the shift amount, adjusts the shift amount in appearance on the projection face for the light modulation device to the substantially same value based on the calculation result. Further, a shift amount of the image projection apparatus 1A in appearance and a shift amount of the image projection apparatus 1B in appearance are ideally the same shift amount. Further, it is allowable if a shift amount of the image projection apparatus 1A in appearance a shift amount of the image projection apparatus 1B in appearance can reduce the deviation amount.

FIG. 20A illustrates a shift amount of a pixel in the first projection image P1 before adjusting the shift amount, and a shift amount of a pixel in the second projection image P2 before adjusting the shift amount. FIG. 20A illustrates a case that the same shift amount is set for the light modulation devices of the first image projection apparatus 1A and the second image projection apparatus 1B. FIG. 20A shows a pixel 75a before the shifting and a pixel 75b after the shifting in captured image data I1 of the first projection image P1 projected by the first image projection apparatus 1A, and a pixel 76a before the shifting and a pixel 76b after the shifting in captured image data 12 of the second projection image P2 projected by the second image projection apparatus 1B.

However, even if the movement controller 12 sets the same shift amount, the shift amount of the pixel in appearance may become different as above described. As illustrated in FIG. 20A, when a pixel width X1 is set for the pixel 75a before the shifting and the pixel 75b after the shifting for the first image projection apparatus 1A, and a pixel width Y1 is set for the pixel 76a before the shifting and the pixel 76b after the shifting for the second image projection apparatus 1B, the difference of the pixel width for one pixel between the first image projection apparatus 1A and the second image projection apparatus 1B can be indicated as the width difference of “Y1-X1” as illustrated in FIG. 20A.

FIG. 20B illustrates a shift amount of a pixel in the first projection image P1, and a shift amount of a pixel in the second projection image P2 after adjusting the shift amount by using the control unit 111. FIG. 20B illustrates a case that the shift amount of the second image projection apparatus 1B is adjusted so that the shift amount between the pixel 76a before the shifting and the pixel 76b after the shifting for the second image projection apparatus 1B becomes equal to the shift amount between the pixel 75a before the shifting and the pixel 75b after the shifting for the first image projection apparatus. Since the shift directions are the same direction for the pixel 75 and the pixel 76, by controlling the shift amount in the width direction, the shift amount in the vertical direction can be set to the same value.

By setting the same value for the shift amount for one pixel for the pixel 75 in the first projection image P1 projected from the first image projection apparatus 1A, and the pixel 76 in the second projection image P2 projected from the second image projection apparatus 1B, and the pixel width Z1 is set for the pixel 76a before the shifting and the pixel 76b after the shifting after the adjustment of the shift amount for the second image projection apparatus 1B, the difference of the pixel width for one pixel between the first image projection apparatus 1A and the second image projection apparatus 1B can be indicated as the width difference of “Z1-X1” as illustrated in FIG. 20B. Therefore, the difference of the pixel width for one pixel can be reduced for the width of “Y1-Z1” as illustrated in FIG. 20B.

For example, when an image having one straight line drawn in the vertical direction for one pixel is projected, the deterioration of visual perception at the overlapping area of the first projection image projected by the first image projection apparatus 1A and the second projection image projected by the second image projection apparatus 1B can be suppressed when the shift amount after the adjustment can become the smallest pixel width when the pixel in appearance is shifted with a given shift amount, a given shift direction and a given cycle as illustrated in FIG. 20B. Therefore, the deterioration of visual perception can be suppressed by changing the shift amount to a value that can set the smallest pixel width as illustrated in FIG. 20B.

### (Sequence of Shift Amount Adjustment)

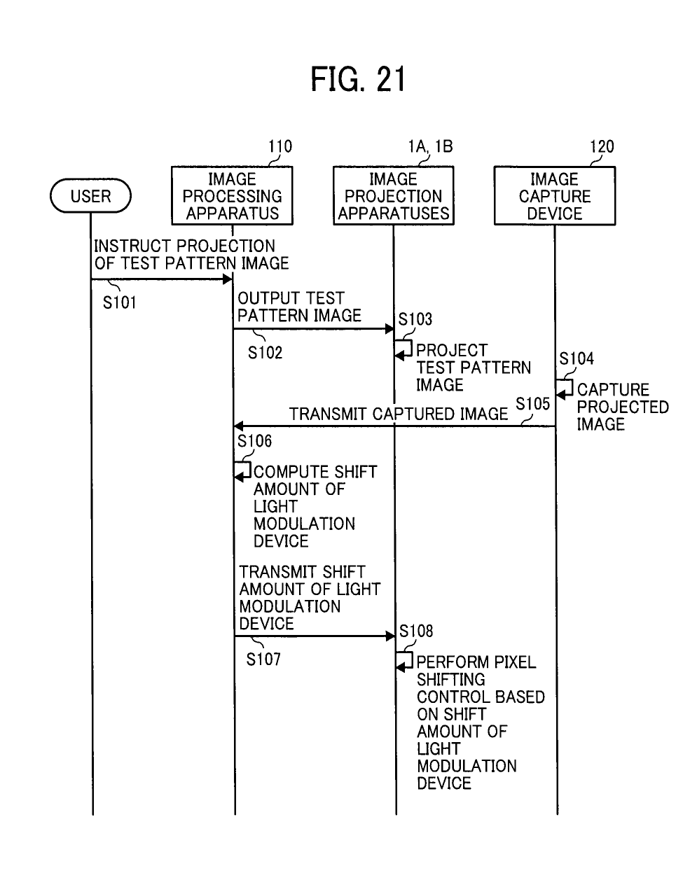

FIG. 21 is one example of a sequence chart of operations of the multi-projection system 100. This sequence is performed with the assumption that the multi-projection system 100 is performing a multi-projection, and a shift control of the light modulation device is performed for the image projection apparatuses 1A and 1B to implement higher resolution. FIG. 21 describes a case that the deviation of the shift amount in appearance in a projection image is adjusted.

A user uses the operation unit 114 to instruct a projection of a test pattern image by using the image projection apparatuses 1 to the image processing apparatus 110 (S101).

When the control unit 111 receives the projection instruction from the operation unit 114, the control unit 111 reads out data of a test pattern image from the storage 118, and the test image output unit 117 outputs the data of the test pattern image to each of the image projection apparatuses 1A and 1B (S102).

When the image projection apparatuses 1A and 1B receive the data of the test pattern image, each of the image projection apparatuses 1A and 1B projects the test pattern image (S103). Then, the image capture device 120 captures the test pattern image projected by the image projection apparatuses 1A and 1B (S104). The capturing by the image capture device 120 can be instructed from the operation unit 114 of the image processing apparatus 110 operable by the user. Further, the capturing by the image capture device 120 can be instructed by the image processing apparatus 110 at a given timing after the projection of the test pattern image is instructed (S101). Further, when the image projection apparatus 1 includes the image capture device 120 therein, the capturing by the image capture device 120 can be instructed by the image projection apparatus 1 at a given timing after projecting the test pattern image.

Then, the image capture device 120 transmits a captured image or captured image data to the image processing apparatus 110 (S105). If the image projection apparatus 1 includes the image capture device 120 therein, the image projection apparatuses 1A and 1B transmit the captured image data to the image processing apparatus 110.

Then, the image processing apparatus 110 performs a computation of the shift amount (S106). Specifically, when the captured data receiver 112 receives the captured image data of the projection images projected by the image projection apparatuses 1A and 1B, the shift amount calculator 111A of the control unit 111 calculates the shift amount for one pixel for each of the first image projection apparatus 1A and the second image projection apparatus 1B based on the captured image.

Further, the shift amount adjuster 111B calculates a deviation amount of the shift amount for one pixel for the first image projection apparatus 1A and the second image projection apparatus 1B based on the shift amount of each of the first image projection apparatus 1A and the second image projection apparatus 1B calculated by the shift amount calculator 111A, and calculates a corrected shift amount of the light modulation devices of the first image projection apparatus 1A and/or the second image projection apparatus 1B to set the same shift amount.

Then, the shift amount output unit 115 transmits the corrected shift amount or adjusted shift amount of the light modulation device calculated at S106 to one of the image projection apparatuses 1 that requires the adjustment of the shift amount (S107).

The movement controller 12 of the image projection apparatus 1 that has received the corrected shift amount changes or adjusts the shift amount of the light modulation device by applying the received corrected shift amount to perform the pixel shifting control (S108).

As to the above described image processing apparatus of the first example embodiment, the light modulation device is shifted to increase the pixel numbers in appearance to form an intermediate image having higher resolution on the screen when the multi-projection is performed. By controlling the shift amount of the light modulation device of the image processing apparatus, deterioration of visual perception at the overlapping area or image stitching portion can be suppressed, and the visual perception can be enhanced to good enough.

As to the conventional multi-projection, when the light modulation device is shifted for a given shift amount to a given direction with a given cycle, the pixel numbers in appearance can be increased, with which images can be projected with higher resolution. However, since the projection distance and projection size differ among the plurality of image projection apparatuses, the shift amount of pixel in appearance differs among the image projection apparatuses, with which the visual perception deteriorates. As to the multi-projection system 100 of one or more example embodiments, the test pattern image is projected on the projection image, and the image capture device (e.g., camera) captures the test pattern image to recognize the difference of the shift amount of pixel in appearance among the image projection apparatuses. Based on the difference of the shift amount of pixel in appearance among the image projection apparatuses, the difference of the shift amount of the light modulation devices (DMD) among the image projection apparatuses can be set to the same value or reduced, with which deterioration of visual perception at the overlapping area or image stitching portion due to the different shift amounts can be suppressed.

### Second Example Embodiment

A description is given of an image processing apparatus and an image projection system of a second example embodiment. The same points described in the first example embodiment may be omitted.

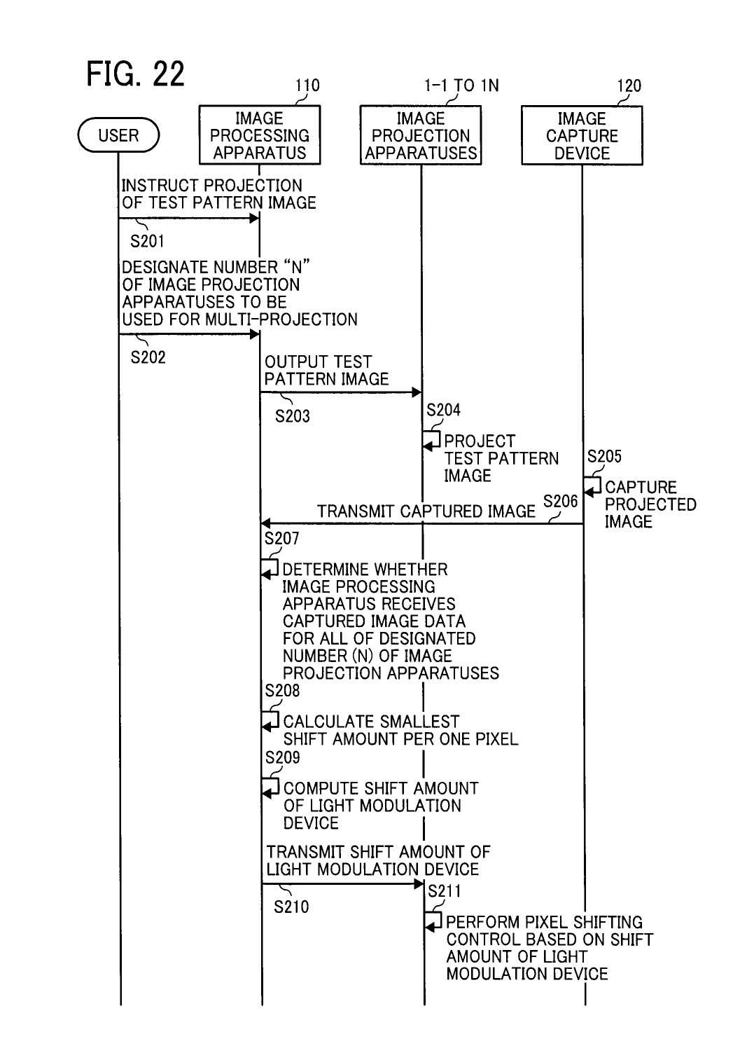

FIG. 22 is another example of a sequence chart of operations of the multi-projection system 100 of the second example embodiment. In the second example embodiment, the shift amount of the light modulation device is adjusted or corrected when the multi-projection is performed by using three or more image projection apparatuses 1-1, 1-2 to 1-N, in which N is natural number of three or more (hereinafter, image projection apparatuses 1-1 to 1-N).

This sequence is performed with the assumption that the multi-projection system 100 is performing a multi-projection, and a shift control of the light modulation device is performed for a plurality of the image projection apparatuses 1-1 to 1-N to implement higher resolution of projection images. FIG. 22 describes a case that the deviation of shift amount in appearance in a projection image is adjusted.

A user uses the operation unit 114 to instruct a projection of a test pattern image by the image projection apparatuses 1-1 to 1-N to the image processing apparatus 110 (S201).

Further, the user designate the number “N” of the image projection apparatuses 1 to be used for the multi-projection to the image processing apparatus 110 by operating the operation unit 114 (S202).

When the control unit 111 receives the projection instruction and the designated number “N” of the image projection apparatuses 1 from the operation unit 114, the control unit 111 reads out data of the test pattern image from the storage 118, and the test image output unit 117 outputs the data of the test pattern image to the image projection apparatuses 1-1 to 1-N that corresponds to the designated number “N” (S203).

When the image projection apparatuses 1-1 to 1-N receive the data of the test pattern image, each of the image projection apparatuses 1-1 to 1-N projects the test pattern image (S204). Then, the image capture device 120 captures the test pattern image projected by each of the image projection apparatuses 1-1 to 1-N (S205). The image capture device 120 transmits the captured images or captured image data to the image processing apparatus 110 (S206).

Then, the image processing apparatus 110 determines whether the image processing apparatus 110 receives the captured image data of the projection images projected by the image projection apparatuses 1-1 to 1-N (S207), in which the captured data receiver 112 of the control unit 111 receives the captured image data, and the shift amount calculator 111A of the control unit 111 determines whether the number of received captured image data is equal to the designated number “N” of the image projection apparatuses 1-1 to 1-N.

If the number of received captured image data is equal to the designated number “N” of the image projection apparatuses 1-1 to 1-N, the shift amount of one pixel is already calculated for each of the captured image data, and the smallest shift amount is determined from the plurality of calculated shift amount (S208).

Then, the image processing apparatus 110 performs a computation of the shift amount (S209). Specifically, the shift amount adjuster 111B of the control unit 111 calculates the shift amount (i.e., corrected shift amount) of the light modulation device of the plurality of the image projection apparatuses 1-1 to 1-N by using the smallest shift amount of one pixel determined at S208 as a reference value when adjusting the deviation among the image projection apparatuses 1-1 to 1-N, with which the same shift amount can be set to the image projection apparatuses 1-1 to 1-N.

Then, the shift amount output unit 115 transmits the corrected shift amount or adjusted shift amount of the light modulation device calculated at S209 to at least one image projection apparatuses among the image projection apparatuses 1-1 to 1-N that requires the adjustment of the shift amount (S210).

The movement controller 12 of at least one image projection apparatus among the image projection apparatuses 1-1 to 1-N, which has received the corrected shift amount of the light modulation device, changes or adjusts the shift amount of the light modulation device by applying the received corrected shift amount to perform the pixel shifting control (S211).

As to the second example embodiment, the shift amount of the projection images in appearance projected by three or more image projection apparatuses can be set to the same value.

As to the above described image processing apparatus of the second example embodiment, when the smallest shift amount is used as the reference value, a risk that the shift amount of the light modulation device exceeds a limit value is reduced while the resolution enhancement level becomes relatively lower. By contrast, when the largest shift amount is used as the reference value, a risk that the shift amount of the light modulation device exceeds a limit value is increased while the resolution enhancement level becomes relatively higher. Therefore, the smallest shift amount or the largest shift amount can be selectively used in view of the desired shift control.

### Third Example Embodiment

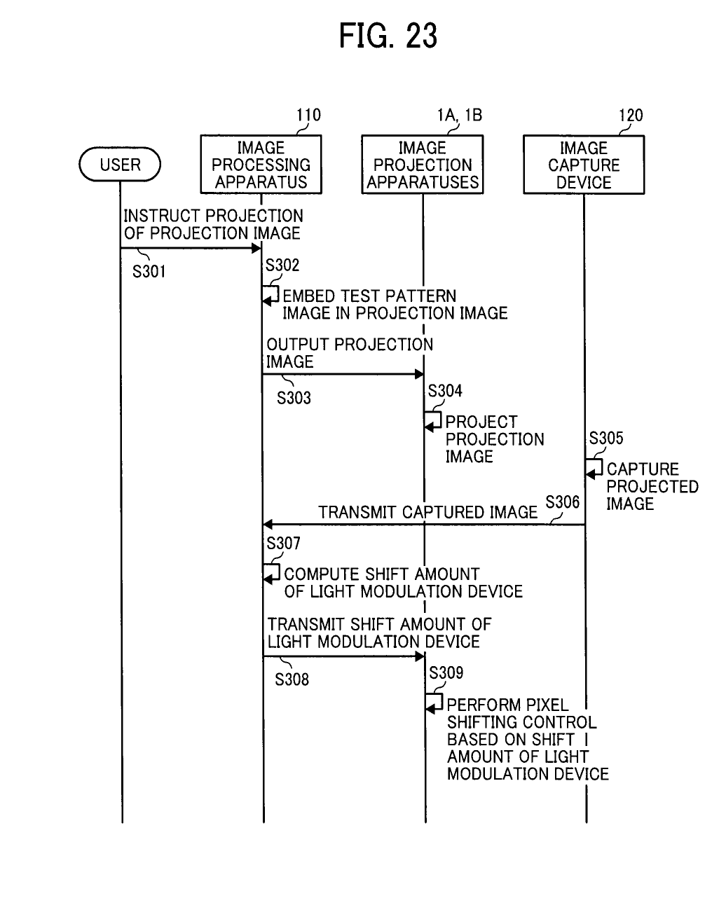

FIG. 23 is an example of a sequence chart of operations of the multi-projection system 100 of a third example embodiment. In the third example embodiment, the shift amount of the light modulation device is adjusted or corrected by embedding a test pattern image in a projection image and then projecting the projection image.

This sequence is performed with the assumption that the multi-projection system 100 is performing a multi-projection, and a shift control of the light modulation device is performed for the image projection apparatuses 1A and 1B to implement higher resolution of projection image. FIG. 23 describes a case that the deviation of the shift amount in appearance in a projection image is adjusted.

A user uses the operation unit 114 to instruct a projection of a test pattern image by the image projection apparatuses 1A and 1B to the image processing apparatus 110 (S301).

At the image processing apparatus 110, the control unit 111 embeds data of the test pattern image in a projection image to be projected to calculate the shift amount of one pixel in appearance (S302).

Then, the image output unit 116 outputs the projection image embedded with the test pattern image to the image projection apparatuses 1A and 1B (S303). When the image projection apparatuses 1A and 1B receive the data of the projection image embedded with the test pattern image, the image projection apparatuses 1A and 1B project the projection image embedded with the test pattern image (S304).

Then, the image capture device 120 captures the projection images projected by the image projection apparatuses 1A and 1B (S305). As to the third example embodiment, the image capture device 120 can be disposed for the multi-projection system 100 as a monitoring camera that monitors projection images at any time as required such as constant monitoring, and captures images with a given time interval to correct the effect of imaging conditions that may change over the time. The image capture device 120 transmits the captured images or captured image data to the image processing apparatus 110 (S306).

The image processing apparatus 110 performs a computation of the shift amount (S307). Specifically, when the captured data receiver 112 receives the captured image data of the projection images projected by the image projection apparatuses 1A and 1B, the shift amount calculator 111A of the control unit 111 calculates the shift amount of one pixel for each of the image projection apparatus 1A and the image projection apparatus 1B based on the captured images. Further, the shift amount adjuster 111B calculates the deviation amount of shift amount one pixel for the image projection apparatus 1A and the image projection apparatus 1B based on the shift amount of each of the image projection apparatus 1A and the image projection apparatus 1B calculated by the shift amount calculator 111A, and calculates the corrected shift amount of the light modulation device of the image projection apparatus 1A and/or the image projection apparatus 1B to set the same shift amount.

Then, the shift amount output unit 115 transmits the corrected shift amount or adjusted shift amount of the light modulation device calculated at S308 to at least one of the image projection apparatuses 1 that requires the adjustment of the shift amount (S308).

The movement controller 12 of the image projection apparatus 1 that has received the corrected shift amount changes or adjusts the shift amount of the light modulation device by applying the received corrected shift amount to perform the pixel shifting control (S309).

As to the third example embodiment, the test pattern image is embedded in the projection image, and the shift amount is calculated from the images captured by the an image capture device (e.g., camera) with a given time interval, with which the shift amount of one pixel in appearance, which may change by the effect of imaging conditions changeable over the time, can be corrected with the given time interval.

As to the above described example embodiments of the multi-projection system employing a plurality of image projection apparatuses that shifts the light modulation device to achieve higher resolution, the shift amount of the light modulation device of each of the image projection apparatuses is controlled to achieve a good level of visual perception at the overlapping area or image stitching portion of the adjacent projection images.

The present invention can be implemented in any convenient form, for example using dedicated hardware platform, or a mixture of dedicated hardware platform and software. Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions. For example, in some embodiments, any one of the information processing apparatus may include a plurality of computing devices, e.g., a server cluster, that are configured to communicate with each other over any type of communication links, including a network, a shared memory, etc. to collectively perform the processes disclosed herein.

The computer software can be provided to the programmable device using any carrier medium or storage medium such as non-volatile memory for storing processor-readable code such as a floppy disk, a flexible disk, a compact disk read only memory (CD-ROM), a compact disk rewritable (CD-RW), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a flash memory, Blu-ray disc (registered trademark), secure digital (SD) card, a solid state memory device or the like, but not limited these. Further, the computer software can be provided through communication lines such as electrical communication line. Further, the computer software can be provided in a read only memory (ROM) disposed for the computer. The computer software stored in the storage medium can be installed to the computer and executed to implement the above described processing. The computer software stored in the storage medium of an external apparatus can be downloaded and installed to the computer via a network to implement the above described processing.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C, C++, C#, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination. Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations for the communication terminal, information processing system, and information processing method, a program to execute the information processing method by a computer, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An image processing apparatus employable for an image projection system configurable with a plurality of image projection apparatuses including at least first and second image projection apparatuses for projecting first and second projection images on a projection face by overlapping a part of the first projection image and a part of the second projection image at an overlapping area, the image processing apparatus comprising:
a shift amount calculator to calculate a pixel shift amount for the first projection image projected by the first image projection apparatus on the projection face, and a pixel shift amount for the second projection image projected by the second image projection apparatus on the projection face when each of the first and second image projection apparatuses performs a shift control of a light modulation device disposed in each of the first and second image projection apparatuses with a given cycle;
a shift amount adjuster to calculate a deviation amount of the pixel shift amount of the first image projection apparatuses and the pixel shift amount of the second image projection apparatus, and calculate a corrected shift amount to set the same pixel shift amount to the first and second image projection apparatuses or to reduce the deviation amount of the pixel shift amount of the first image projection apparatus and the pixel shift amount of the second image projection apparatus; and
a shift amount output unit to transmit the corrected shift amount to at least one of first and second image projection apparatus that requires a correction of the pixel shift amount.

2. The image processing apparatus of claim 1, wherein the shift amount calculator calculates the pixel shift amount of each of the first and second image projection apparatus based on image data of a test pattern image projected by each of the first and second image projection apparatuses on a projection face, and captured by an image capture device.

3. The image processing apparatus of claim 2, further comprising a test pattern image output unit to transmit the test pattern image to the first and second image projection apparatuses.

4. The image processing apparatus of claim 2, further comprising an operation unit that receives a projection instruction of the test pattern image, or the projection instruction of the test pattern image and a number of the plurality of image projection apparatuses to be used for the image projection.

5. The image processing apparatus of claim 1, wherein the shift amount adjuster calculates the deviation amount based on the smallest pixel shift amount among the plurality of the pixel shift amount of the plurality of image projection apparatuses as a first reference value, and calculates a corrected shift amount used for at least one of the image projection apparatuses based on the first reference value.

6. The image processing apparatus of claim 1, wherein the shift amount adjuster calculates the deviation amount based on the largest pixel shift amount among the plurality of the pixel shift amount of the plurality of image projection apparatuses as a second reference value, and calculates a corrected shift amount used for at least one of the image projection apparatuses based on the second reference value.

7. The image processing apparatus of claim 1, further comprising an image output unit to transmit a projection image embedded with the test pattern image to each of the plurality of image projection apparatuses.

8. An image projection system comprising:
the image processing apparatus of claim 1 including a shift-movement controller; and
a plurality of image projection apparatuses, each of the image projection apparatuses including:
a light source to emit light;
an image generation unit including a light modulation device to generate an image by using the light emitted from the light source;
a light guide unit to guide the light emitted from the light source to the image generation unit; and
a projection unit to project the image generated by the image generation unit;
wherein the shift-movement controller controls a shift amount of the light modulation device disposed in the each of the image projection apparatuses based on the corrected shift amount transmitted from the shift amount output unit.

9. The image projection system of claim 8, further comprising an image capture device disposed inside one or more of the image projection apparatuses or disposed outside the image projection apparatuses to capture test pattern images projected on the projection face from the plurality of image projection apparatuses,
wherein the shift amount calculator calculates the pixel shift amount for each of the projection images on a projection face based on image data of the test pattern images captured by the image capture device.
